(19) United States
(12) Patent Application Publication
(10) Pub. No.: US 2012/0005016 A1
(43) Pub. Date: Jan. 5, 2012

(54) Methods and System for Providing and Analyzing Local Targeted Advertising Campaigns

(76) Inventor: Uri Graff, Haifa (IL)

(21) Appl. No.: 12/827,350

(22) Filed: Jun. 30, 2010

(51) Int. Cl. G06Q 30/00; G06F 15/16; G06F 15/173

(52) U.S. Cl. 705/14.49; 705/1.1; 709/223; 709/219; 705/27.1

(57) ABSTRACT

The present invention relates to methods and a system for providing a local targeted advertising campaign with regard to at least one predefined physical site, one of said method comprising: (a) providing a semantic network having a plurality of segmentation paths, wherein each segmentation path is related to a predefined physical site and includes at least two interconnected nodes; (b) providing at least one metrics to a node from said at least two nodes; (c) inheriting said at least one metrics from said node to a higher-level node from among said at least two interconnected nodes; and (d) providing a local targeted advertising campaign with regard to at least one predefined physical site based on said inheriting of said at least one metrics.

### FIELD OF THE INVENTION

The present invention relates to the field of mobile communication. More specifically, the present invention relates to methods and a system for enabling to provide and analyze targeted advertising campaigns with regard to a predefined semantic network and with regard to a predefined physical site.

### DEFINITIONS, ACRONYMS AND ABBREVIATIONS

Throughout this specification, the following definitions are employed:

Context-Aware Computing: is a concept of leveraging information about the end user to improve the quality of interaction by analyzing the end user behavior along with variant environmental information in order to anticipate the end user's needs.

### BACKGROUND OF THE INVENTION

The shopping journey of consumers within the shopping facilities, such as shopping malls, is still not considered as an easy task to quickly determine relevant, personal and trustworthy information. Also, the need to “get it right first time” is much stronger for the mobile device consumers, which communicate over a wireless (e.g., cellular) network during their shopping journey, than for the same consumers who are at home and communicate over a wired network (e.g., the wired Internet). Therefore, companies increasingly invest in targeted campaigns in order to reach targeted consumers at local markets, such as shopping malls, marketplaces, and the like.

According to recent market researches, the traditional advertising campaigns focus on mass advertising media, such as TV (television), radio, and the like. In turn, consumers are bombarded by mass-marketing messages, which are usually not relevant and/or not in the right context for consumers at a specific time and place (location) during each consumer's shopping journey. As a result, the need for consumers' target advertising and target marketing is significantly growing worldwide.

Location based services (LBS) are critical for enabling consumers to reach relevant information over a data network by means of their mobile devices. For example, cross-correlating search query results and location-based information, such as the consumer's location, might provide consumer-relevant information. However, the providing of immediate, personal and relevant information to consumers requires much more contextual factors, than just location, in order to satisfy consumer's dynamic needs with regard to particular target local market. For example, it is supposed that a consumer searches for the term “man shirt” in a shopping mall, which includes more than a hundred shops (e.g., points of sale (POS)). In such a case, there is significant importance of additional contextual factors that might reduce the scope of information (e.g., recommended shops selected from the above hundred shops) exposed to the consumer. Such factors may relate to the local marketing environment, dynamic consumer preferences, and spatial structure of local markets, which will enable to reduce relevant information with regard to a shopping area of a particular interest to the consumer, such as a particular shopping building. Thus, information relevancy may be significantly dependent on the local marketing environment. For example, the targeted information related to specific categories (e.g., “shoes”, “clothes”) of a particular shopping mall may dramatically reduce the scope of information exposed to the consumer. However, determining each consumer's relevant information involves determining not only category's content but also category's context. For example, a consumer who is physically located inside a women shoes shop and searches for the term “evening shoes”, may actually be interested in women evening shoes. In addition, marketers (e.g., advertisers) may wish to continuously customize their targeted information marketing environment depending on the local market response and trends with regard to their current targeted campaign. For example, a sport shoes retailer that publishes targeted information under the “sport shoes” category may wish to reduce the target market segment to the “teenagers sport shoes” category in order to increase the probability to reach target consumers.

Also, according to the prior art, consumers can be exposed to relevant information based on recommendations (selected targeted content). These recommendations can be related to each consumer's preferences that can be identified by analyzing each consumer's behavior. However, consumers' preferences during their shopping journey are usually non-static. Moreover, an average consumer may change and swap “personality” either during a particular shopping journey or a particular shopping season (e.g., winter, summer). Thus, for example, a consumer can look for restaurants and entertainments at a weekend and look for children clothes during the rest time of the week. For another example, a consumer can look for children clothes at the beginning of his shopping journey, and then look for adult clothes. Further, a consumer may look for a coat during the winter time, and look for a T-shirt during the summer time. Therefore, by providing personal selected targeted content based on each consumer's profile (that contains dynamically varying preferences) may overcome the above-identified problems.

In addition, according to the prior art, consumers' personal information may be used by a 3-rd party, which can lead to identifying and exposing each consumer's personality. As a result, this may cause significant security conflicts with regard to consumers' privacy. Therefore, there is a strong need in the art for a method and system, which does not make any use of private information, such as demographic and socioeconomic information, and does not require consumers to fill any personal questionnaire as well.

The digital media prior art technologies suggest a wide range of opportunities for advertisers. However, these technologies are still more focused on the online advertising for immobile desktop users, who have usually plenty of time, and are less focused on the real-time local advertising for mobile web users in local markets (e.g., particular shopping malls). As a result, advertisers still face difficulties to reach target consumers who almost have made their purchasing decision and are mostly physically located nearby the desired point of sale. In addition, some of these prior art technologies are focused on collecting mobile device data, in which mobile carrier communities are mainly interested, and these prior art technologies are usually less focused on various local market factors. As a result, advertisers still face difficulties to accurately assess their advertising campaigns at the local markets.

US2008/0059300 discloses various techniques for improving the delivery of mobile ads to devices. According to US2008/0059300, ads are matched with parameters passed to an ad source and then delivered to a publisher to be included with downloaded content. Also, ads may be targeted to specific devices as specified by an advertiser. Further, targeting information may be gathered from the device and from information previously provided to the publisher.

US 2005/0222901 presents a method, according to which ad information, such as ad targeting keywords and/or ad creative content for example, may be determined using aggregated selected document-to-query information associations. For example, popular terms and/or phrases also associated with a selected document may be used as ad targeting keywords and/or ad creative content for an ad having the document as a landing page. Query information may be tracked on a per document level, a per domain level, etc. The determined ad information may be used to automatically populate an ad record, or may be provided to an advertiser as suggested or recommended ad information.

US 2005/0222989 discloses a system, in which personalized advertisements are provided to a user using a search engine to obtain documents relevant to a search query. The advertisements are personalized in response to a search profile that is derived from personalized search results. The search results are personalized based on a user profile of the user providing the query. According to US 2005/0222989, the user profile describes interests of the user, and can be derived from a variety of sources, including prior search queries, prior search results, expressed interests, demographic, geographic, psychographic, and activity information.

It should be noted that according to the prior art, conventional search engines are usually focused on indexing Internet page contents. Also, in recent years, several search engines started to index various location-based information. However, this location-based information is usually limited due to the following factors: (a) lack of contextual information search techniques that involve structured contextual marketing information, which can be customized online (in real-time) by retail points of sale; (b) relatively insufficient differentiation between the retail points of sale and products/services being sold; (c) relatively insufficient contextual correlation between these points of sale and products/services; and (d) relatively insufficient cycle time of updating the location-based information.

US 2009/0265251 discloses systems and methods for searching a defined area. In one embodiment, US 2009/0265251 presents a method comprising receiving a plurality of product data, wherein the product data describes a plurality of products offered for sale by a plurality of businesses. A user may enter a search request, and the system searches product data for a plurality of products in a plurality of point-of-sale stores in the defined area.

U.S. Pat. No. 7,548,915 discloses a method for displaying mobile content in association with a website on a mobile communication facility, based at least in part on receiving a website request from a mobile carrier gateway, receiving contextual information relating to the requested website, associating the received contextual information with a mobile content, and, finally, displaying the mobile content with the website on a mobile communication facility.

U.S. Pat. No. 7,577,665 presents a method for mobile communication facilities, such as cell phones. According to U.S. Pat. No. 7,577,665, information relating to the user characteristics associated with a mobile communication facility and other capabilities are employed to improve the presentation and relevance of mobile content to appropriate or desirable mobile communication facilities.

Therefore, the prior art drawbacks are well known, and there is a continuous need in the art to provide an online contextual methods and a system, which in turn provide substantially real-time contextual target information (such as recommendations/selected targeted content) that enable, on one hand, advertisers to publish contextual target content, and on the other hand, assist consumers to receive substantially immediate, personal and relevant information by means of their mobile devices over a data network, such as a cellular network with regard to predefined physical local market (e.g., shopping malls). In addition, there is a continuous need in the art to enable efficiently determine and calculate various metrics with regard to a predefined physical site (e.g., local market facilities such as a shopping mall), and also analyze targeted advertising campaign performances with regard to the above predefined physical site, thereby enabling the advertisers efficiently determine the cost-effectiveness of their targeted advertising campaigns.

### SUMMARY OF THE INVENTION

The present invention relates to methods and a system for enabling to provide and analyze targeted advertising campaigns with regard to a predefined semantic network and with regard to a predefined physical site.

According to an embodiment of the present invention, is presented a method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes;
b) providing at least one metrics to a node from said at least two nodes;
c) inheriting said at least one metrics from said node to a higher-level node from among said at least two interconnected nodes; and
d) providing a local targeted advertising campaign with regard to at least one predefined physical site based on said inheriting of said at least one metrics.

According to another embodiment of the present invention, the method further comprises defining the semantic network by the following:
a) providing a spatial structure of physical locations of a plurality of entities within the predefined physical site;
b) providing a marketing environment of said predefined physical site, said marketing environment comprising data related to one of advertisements and sale promotions provided within said predefined physical site; and
c) providing a plurality of advertisers, which enable to interlink between said spatial structure with said marketing environment.

According to still another embodiment of the present invention, the spatial structure comprises at least one of the following:
a) a building;
b) a building floor;
c) open spaces;
d) cells;
e) cell layers; and
f) walking paths.

According to still another embodiment of the present invention, the local marketing environment comprises at least one of the following:
a) a plurality of targeted content data objects; and
b) a plurality of category objects.

According to still another embodiment of the present invention, the advertiser is related to at least one of the following:
a) a point of sale provider;
b) a service provider;
c) a product provider;
d) an advertising campaign provider; and
e) a local market operator.

According to a further embodiment of the present invention, the semantic network is dynamically updated.

According to a particular embodiment of the present invention, the predefined physical site is a predefined shopping site.

According to an embodiment of the present invention, the method further comprises assigning each consumer with a unique identification number (ID), when said anonymous consumer connects to the predefined shopping site over the semantic network, thereby enabling said consumer to remain the anonymous consumer of said predefined shopping site.

According to another embodiment of the present invention, the method further comprises calculating the at least one metrics with regard to the behavior of the anonymous consumer who is connected to the predefined shopping site.

According to still another embodiment of the present invention, the method further comprises calculating the at least one metrics with regard to a group of consumers of the predefined shopping site.

According to still another embodiment of the present invention, the method further comprises providing at least one report to the plurality of advertisers with regard to the at least one calculated metrics.

According to still another embodiment of the present invention, the method further comprises analyzing the a result of the at least one calculated metrics for determining a plurality of factors that influenced on said result, said factors comprising:
a) the location of the predefined physical site;
b) the location the point-of-sale (POS) within said predefined physical site;
c) the location of a particular region of each point-of-sale;
d) the spatial structure of said predefined physical site;
e) at least one targeted content item provided at the predefined physical site;
f) the location of a product or service related to at least one target content item provided within the predefined physical site;
g) a category of said targeted content item; and
h) the calendar time interval, to which the metrics is related.

According to still another embodiment of the present invention, the method further comprises providing at least one report to the plurality of advertisers with regard to the analyzing of the result of the at least one metrics.

According to a further embodiment of the present invention, the method further comprises providing the at least one report substantially in real-time.

According to still a further embodiment of the present invention, the method further comprises informing a plurality of consumers regarding a sale promotion for one of at least one product and service substantially in real-time.

According to still a further embodiment of the present invention, the method further comprises enabling to compare a plurality of metrics with regard to the semantic network and with regard to the at least one predefined physical site.

According to still a further embodiment of the present invention, the metrics is selected from at least one of the following:
a) a statistical metrics;
b) a segmentation path rank metrics;
c) a personal consumer preferences rank metrics;
d) a consumer community preference rank metrics;
e) a target distance metrics; and
f) a market response metrics.

According to still a further embodiment of the present invention, the method further comprises providing an effectiveness rank of the local targeted campaign based on the at least one metrics.

According to another embodiment of the present invention, is presented a method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes, said semantic network defined by:
   a.1. providing a spatial structure of physical locations of a plurality of entities within said predefined physical site;
   a.2. providing a marketing environment of said predefined physical site, said marketing environment comprising data related to one of advertisements and sale promotions provided within said predefined physical site; and
   a.3. providing a plurality of advertisers, which enable to interlink between said spatial structure with said marketing environment;
b) defining each node within said at least two interconnected nodes as one of a category, giving rise to a higher-level node, and a sub-category, giving rise to a lower-level node;
c) calculating the at least one metrics of the targeted advertising campaign by utilizing said semantic network, while providing at least one metrics to a node from said at least two nodes and inheriting said at least one metrics from said node to a higher-level node from among the at least two interconnected nodes; and
d) providing a local targeted advertising campaign with regard to the at least one predefined physical site based on the inheriting of said at least one metrics.

According to still another embodiment of the present invention, is presented a method of enabling to perform a consolidation with regard to a predefined physical site, said method comprising:
a) providing a semantic network having a plurality of segmentation paths, wherein each segmentation path is related to a predefined physical site and includes at least two interconnected nodes;
b) determining at least two similar segmentation paths within said semantic network, according to at least one predefined criterion; and
c) performing a consolidation of at least two nodes of each of said at least two similar segmentation paths, based on said predefined criterion, giving rise to at least one consolidated segmentation path.

According to an embodiment of the present invention, the at least one predefined criterion relates to at least one of the following:
a) a typo error;
b) a marketing filtering; and
c) a praise words usage.

According to another embodiment of the present invention, the marketing filtering relates to the filtering of at least two similar market segments.

According to still another embodiment of the present invention, the method further comprises defining the semantic network by the following:
a) providing a spatial structure of physical locations of a plurality of entities within the predefined physical site;
b) providing a marketing environment of said predefined physical site, said marketing environment comprising data related to one of advertisements and sale promotions provided within said predefined physical site; and
c) providing a plurality of advertisers, which enable to interlink between said spatial structure with said marketing environment.

According to an embodiment of the present invention, the method further comprises calculating at least one metrics of at least one of the following:
a) at least one segmentation path;
b) at least one consolidated segmentation path;
c) at least one node of said at least one segmentation path; and
d) at least one node of said at least one consolidated segmentation path.

According to another embodiment of the present invention, the method further comprises inheriting the at least one metrics between nodes of each segmentation path.

According to still another embodiment of the present invention, the nodes of each segmentation path form a hierarchical structure.

According to still another embodiment of the present invention, each node of the each segmentation path is one of the following:
a) a category, thereby the node as a higher-level node; and
b) a sub-category, thereby the node as a lower-level node.

According to a further embodiment of the present invention, the method further comprises performing the consolidation of one of the category and sub-category.

According to still a further embodiment of the present invention, the method further comprises removing the segmentation paths which are at least one of the following:
a) not used for a predefined period of time;
b) are determined as redundant; and
c) are determined as non-effective.

According to an embodiment of the present invention, a server is configured to perform at least one metrics of a targeted advertising campaign by utilizing a semantic network with regard to a predefined physical site, said server comprising:
a) a local network database configured to store a semantic network that comprises a plurality of segmentation paths, wherein each segmentation path is related to a predefined physical site and includes at least two interconnected nodes, and wherein said semantic network is defined by:
   a.1. a spatial structure of physical locations of a plurality of entities within said predefined physical site;
   a.2. a marketing environment of said predefined physical site, said marketing environment comprising data related to one of advertisements and sale promotions provided within said predefined physical site; and
   a.3. a plurality of advertisers, which enable to interlink between said spatial structure with said marketing environment; and
b) a targeted campaign analyzing unit configured to enable the advertisers to assess and control their advertising campaigns, and enabling to calculate at least one metrics of the targeted advertising campaign over said semantic network.

According to an embodiment of the present invention, the server further comprises a search engine unit configured to enable conducting a search for at least one item over the semantic network.

According to another embodiment of the present invention, the server further comprises a locator unit configured to acquire locations of consumers' mobile devices.

According to still another embodiment of the present invention, the locator unit further is configured to identify anonymous consumers based on the acquired locations.

According to still another embodiment of the present invention, the server further comprises a data acquiring unit configured to gather targeting information provided by a plurality of advertisers.

According to still another embodiment of the present invention, the data acquiring unit further processes and integrates the targeting information within the local network database.

According to a further embodiment of the present invention, the server further comprises a shopping map unit configured to provide contextual information to a plurality of consumers by using location base services (LBS).

According to still a further embodiment of the present invention, the server further comprises a local content exposure unit configured to enable a plurality of consumers to operate the contextual information.

According to still a further embodiment of the present invention, the server further comprises a consumer preference unit configured to perform at least one of the following:
a) gather selections of each consumer, which are made by the mobile device of said each consumer, giving a rise to the gathered consumer selections;
b) analyze the gathered consumer selections and transform these selections to one or more consumer preferences; and
c) store said consumer preferences within a consumers preferences database.

According to an embodiment of the present invention, the server further comprises a targeted campaign monetization unit configured to monetize targeted campaigns by measuring traffic of the contextual information.

According to still another embodiment of the present invention, the server further comprises an advertisers' database configured to store advertisers' details for managing and billing the advertisers' accounts.

According to still another embodiment of the present invention, the server further comprises a local schedule unit for enabling synchronizing at least a portion of units, which are one of provided and connected to said server.

According to still another embodiment of the present invention, the metrics is selected from at least one of the following:
a) a statistical metrics;
b) a segmentation path rank metrics;
c) a personal consumer preferences rank metrics;
d) a consumer community preference rank metrics;
e) a target distance metrics; and
f) a market response metrics.

According to still another embodiment of the present invention, the server further enables to:
a) provide the at least one metrics to a node from the at least two nodes; and
b) inherit said at least one metrics from said node to a higher-level node from among said at least two interconnected nodes.

According to an embodiment of the present invention, a system is configured to provide a local targeted advertising campaign with regard to at least one predefined physical site.

According to another embodiment of the present invention, the system further comprises a remote consumer services apparatus configured to enable connecting mobile devices of a plurality of consumers to the at least one server.

According to another embodiment of the present invention, the system further comprises a remote advertiser services apparatus configured to enable connecting devices of a plurality of advertisers to the at least one server.

According to a further embodiment of the present invention, is presented a method of awarding a consumer based on the consumer's activity with regard to a predefined physical site, said activity performed by means of the consumer's mobile device, said method comprising:
a) providing a semantic network having a plurality of segmentation paths, wherein each segmentation path is related to a predefined physical site and includes at least two interconnected nodes, while each node within said at least two interconnected nodes is one of a category, giving rise to a higher-level node, and a sub-category, giving rise to a lower-level node;
b) enabling the consumer to perform an activity with regard to said predefined physical site and said semantic network; and
c) award said consumer based on said activity.

According to an embodiment of the present invention, the awarding of the consumer is performed by an advertiser.

According to another embodiment of the present invention, the activity is related to with the semantic network and to the predefined physical site.

According to still another embodiment of the present invention, the awarding comprises providing to the consumer at least one of the following:
a) a coupon;
b) a discount;
c) a voucher; and
d) a gift.

According to still another embodiment of the present invention, the method further comprises awarding the consumer substantially in real-time.

According to an embodiment of the present invention, is presented a program storage device readable by machine, tangibly embodying a program of instructions executable by the machine to perform a method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes;
b) providing at least one metrics to a node from said at least two nodes;
c) inheriting said at least one metrics from said node to a higher-level node from among said at least two interconnected nodes; and
d) providing a local targeted advertising campaign with regard to at least one predefined physical site based on said inheriting of said at least one metrics.

According to another embodiment of the present invention, is presented a program storage device readable by machine, tangibly embodying a program of instructions executable by the machine to perform a method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes, said semantic network defined by:
   a.1. providing a spatial structure of physical locations of a plurality of entities within said predefined physical site;
   a.2. providing a marketing environment of said predefined physical site, said marketing environment comprising data related to one of advertisements and sale promotions provided within said predefined physical site; and
   a.3. providing a plurality of advertisers, which enable to interlink between said spatial structure with said marketing environment;
b) defining each node within said at least two interconnected nodes as one of a category, giving rise to a higher-level node, and a sub-category, giving rise to a lower-level node;
c) calculating the at least one metrics of the targeted advertising campaign by utilizing said semantic network, while providing at least one metrics to a node from said at least two nodes and inheriting said at least one metrics from said node to a higher-level node from among the at least two interconnected nodes; and
d) providing a local targeted advertising campaign with regard to the at least one predefined physical site based on the inheriting of said at least one metrics.

According to still another embodiment of the present invention, is presented a program storage device readable by machine, tangibly embodying a program of instructions executable by the machine to perform a method of enabling to perform a consolidation with regard to a predefined physical site, said method comprising:
a) providing a semantic network having a plurality of segmentation paths, wherein each segmentation path is related to a predefined physical site and includes at least two interconnected nodes;
b) determining at least two similar segmentation paths within said semantic network, according to at least one predefined criterion; and
c) performing a consolidation of at least two nodes of each of said at least two similar segmentation paths, based on said predefined criterion, giving rise to at least one consolidated segmentation path.

According to a further embodiment of the present invention, is presented a program storage device readable by machine, tangibly embodying a program of instructions executable by the machine to perform a method of awarding a consumer based on the consumer's activity with regard to a predefined physical site, said activity performed by means of the consumer's mobile device, said method comprising:
a) providing a semantic network having a plurality of segmentation paths, wherein each segmentation path is related to a predefined physical site and includes at least two interconnected nodes, while each node within said at least two interconnected nodes is one of a category, giving rise to a higher-level node, and a sub-category, giving rise to a lower-level node;
b) enabling the consumer to perform an activity with regard to said predefined physical site and said semantic network; and
c) awarding the consumer based on said activity.

### BRIEF DESCRIPTION OF THE DRAWINGS

In order to understand the invention and to see how it may be carried out in practice, various embodiments will now be described, by way of non-limiting examples only, with reference to the accompanying drawings, in which:

FIG. 1 is a schematic block diagram of a context-aware system for enabling context-aware services for local market advertisers and consumers, according to an embodiment of the present invention;

FIG. 2 is a schematic flow-chart of a method for deploying the local market context-aware system, according to an embodiment of the present invention;

FIG. 3 is a sample schematic illustration of a local market spatial structure, according to an embodiment of the present invention;

FIG. 4 is a sample schematic network diagram of a general local market semantic network, according to an embodiment of the present invention;

FIG. 5 is a particular schematic network diagram of a general local market semantic network, according to an embodiment of the present invention;

FIG. 6 is a schematic flow-chart of a method for publishing the contextual local targeted content, according to an embodiment of the present invention;

FIGS. 7A and 7B are schematic flow-charts of a category deconsolidating method and a category consolidating method, respectively, according to an embodiment of the present invention;

FIG. 7C is a schematic illustration of a sample category consolidation, according to an embodiment of the present invention;

FIG. 8A is a schematic flow-chart of the reciprocal data transfer between consumers' and advertisers' devices, according to an embodiment of the present invention;

FIG. 8B is a particular diagram of consumer's preferences, according to an embodiment of the present invention;

FIG. 9 is a state-machine block-diagram, which represents possible states of a system with regard to particular consumer activities, which are determined and managed by said system, according to an embodiment of the present invention;

FIG. 10 is a sample sequence (interaction) diagram for enabling and measuring both targeted content and context exchange, according to an embodiment of the present invention;

FIG. 11 is a sample flow chart of a contextual local market search method, according to an embodiment of the present invention;

FIG. 12 schematically illustrates a contextual search query interface, according to an embodiment of the present invention;

FIG. 13 presents a sample illustration of contextual shopping map interface for enabling consumers to obtain selected targeted content with regard to a particular local market area as well as enabling acquiring each consumer's selections, according to an embodiment of the present invention;

FIG. 14 presents a targeted content exposure interface for enabling consumers to expose the targeted content and context data, and for enabling acquiring data that indicate consumers' selections, according to an embodiment of the present invention; and

FIG. 15 is a schematic flow-cart for determining targeted advertising campaign performances, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE EMBODIMENTS

Unless specifically stated otherwise, as apparent from the following discussions, it is appreciated that throughout the specification discussions utilizing terms such as “processing”, “computing”, “calculating”, “determining”, or the like, refer to the action and/or processes of a computer that manipulate and/or transform data into other data, said data represented as physical, e.g. such as electronic, quantities. The term “computer” should be expansively construed to cover any kind of electronic device with data processing capabilities, including, by way of non-limiting example, personal computers, servers, computing systems, communication devices, processors (e.g. digital signal processor (DSP), microcontrollers, field programmable gate array (FPGA), application specific integrated circuit (ASIC), etc.) and other electronic computing devices. Also, operations in accordance with the teachings herein may be performed by a computer specially constructed for the desired purposes or by a general purpose computer specially configured for the desired purpose by a computer program stored in a computer readable storage medium.

Hereinafter, wherein the term “mobile device” is used, it relates to any mobile device, such as a smartphone (e.g., iPhone®), PDA (Personal Digital Assistant), cellular phone, and the like. Also, wherein the term “local market” is used it should be noted that it refers to any local market, such as a mall, shopping center, roofed and/or open local market, airport, port, central train station, central bus station, exhibition, bazaar, park, and any other local business area. In addition, although the present invention is described in the view of the local market facilities, it also relates to any other type of facilities. Further, it should be noted that when the term “local market factors” or “market factors” is used, it relates to the factors such as market segments (marketing); market categories; spatial structure of the market; market facilities; local business/point of sales; available inventory; product/services attributes; market positioning of product/services (marketing); products/services prices; sale promotion proposals (e.g., coupons, vouchers, business club membership, etc.); brands being related to at least one local product/service or to at least one local business or at least one local market; local market consumer community preferences; local business opening hours; and the like. Moreover, it should be noted that the term “Local Targeted Content” (LTC) represents digital advertizing data as well as digital sale promotion data of “LTC objects” that can be exposed to targeted consumers at a particular local market by using any type of data communication (e.g., a cellular communication). Further, the term “LTC object” refers to a product, service, or general information that can be advertized or promoted to each target consumer over a data network (such as the Internet, cellular network, etc.). Also, the “LTC data object” refers to a data object managed by a computer system, which represents the LTC (thereby it differs from the term a “LTC object”).

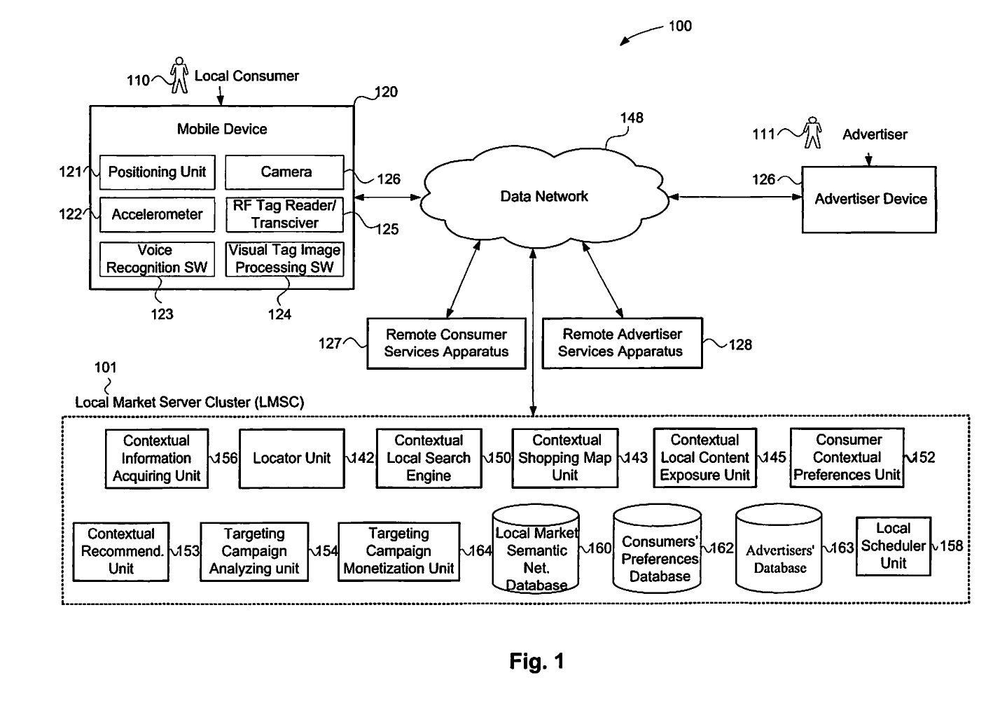

FIG. 1 is a schematic block diagram of a context-aware system 100 for enabling context-aware services for local market advertisers (e.g., product/service providers) and consumers, according to an embodiment of the present invention. System 100 enables a plurality of advertisers to conduct targeted campaigns at plural local markets as well as enables to access and control these campaigns. According to this embodiment, system 100 provide substantially immediate (substantially real-time), personal and relevant information to a plurality of local market consumers (e.g., provides selected targeted content to a mobile device 120 of each consumer) over a data network 148, such as the Internet, cellular network, or any other network.

According to an embodiment of the present invention, system 100 comprises: (a) a Local Market Server Cluster (LMSC) 101 for enabling advertisers 111 to manage targeted campaigns at one or more local markets (e.g., one or more shopping malls) over a data network as well as enabling providing substantially real-time, personal and relevant information for a plurality of local markets consumers 110; (b) a remote consumer services apparatus 127 for connecting a plurality of consumers' mobile devices 110 to at least one LMSC (such as LMSC 101) over data network 148; and (c) a remote advertiser services apparatus 128 for connecting a plurality of advertisers' devices 126 (e.g., mobile devices, PCs (personal computers), and the like) to said at least one LMSC 101 over said data network 148.

According to an embodiment of the present invention, LMSC 101 comprises the following units: Contextual Information Acquiring Unit 156 for enabling gathering local targeting information provided online by subscribed advertisers as well as processing and integrating this information in at least one Local Market Semantic Network Database 160; Locator unit 142 for enabling to acquire locations of a plurality of consumers' mobile devices 120 and, in turn, enabling to identify anonymous consumers 110 based on the acquired locations; Contextual Local Search Engine 150 for enabling consumers to conduct a search, substantially in real-time, by means of their mobile devices 120 over a data network 148 for at least one item (such as a product, service, point of sale, etc.) that is related to a predefined physical site (e.g., a local market), and in turn, provide to said consumers corresponding contextual local search results; Contextual Shopping Map unit 143 for providing contextual information to said consumers 110 by using location base services (LBS); Contextual Local Content Exposure unit 145 for enabling consumers 110 to view, play, exchange, preserve, browse, etc. (i.e. operate) the contextual information over said data network 148; Consumer Contextual Preferences unit 152 for enabling, for example, the following: gathering consumer selections, such as determining the selected product or service, which are made by using mobile device 120, analyzing the gathered consumer selections and transforming these selections to one or more consumer contextual preferences, and then storing said consumer contextual preferences within Consumers' Preferences Database 162; Contextual Recommendation unit 153 for analyzing various data (e.g., each consumer selections) and providing a plurality of shopping recommendations (i.e., selected targeted content) to consumers' mobile devices 120 over data network 148; Targeted Campaign Analyzing unit 154 for enabling advertisers 111 to assess and control their targeting advertising campaigns by conducting, for example, context-aware market response analysis over a data network 148; Targeted Campaign Monetizing unit 164 for monetizing targeted campaigns by measuring traffic of the contextual information at one or more local markets; Advertisers' Database 163 for storing subscribed advertisers' details, which in turn enable managing and billing the subscribed advertisers' accounts; Local Scheduler unit 158 for enabling synchronizing all (or a portion of) units within the LMSC 101, at a particular local market, by generating for example local market time tags; (8) Local Market Semantic Database 160 for storing and retrieving a semantic network that represents local context aware relations between variant local market factors (e.g., market segments, market categories, spatial structure of the market, etc.) and targeted contents (e.g., advertizing data, sale promotion data, etc.).

It should be noted that according to an embodiment of the present invention, each of the above units of LMSC 101 can be either configured as a standalone server or configured as integrated units installed on at least one multi-units server. Also, according to another embodiment of the present invention, one or more units of LMSC 101 can be connected by the secured VPN (Virtual Private Network) over data network 148 for increasing the system 100 security (e.g., for protecting consumers' private information).

According to still another embodiment of the present invention, Locator unit 142 (FIG. 1) determines the location of an anonymous consumer by associating the identification (ID) of mobile device 120 of said anonymous consumer with the current location of said mobile device 120, which in turn can be acquired, for example, by: a positioning unit 121 that is connected to (or integrated within) mobile device 120, cellular transceivers, wireless access points, and other conventional communication means and methods, which enable to determine the mobile device location. Further, it should be noted that the mobile device location can be determined either actively (manually) by consumer's operations that can be related to particular locations, or passively (automatically) by using mobile device integrated positioning unit 121, for example. The positioning unit 121 can be based, for example, on conventional prior art techniques, such as triangulation methods, cellular cell identification methods, by determining cellular signal strength, by determining a geographic location provided by a GPS (Global Positioning System) module, which can be further connected to mobile device 120, and the like. The location determined by means of positioning unit 121 is then sent to Locator unit 142, which can be provided, for example, within LMSC 101. According to an embodiment of the present invention, the Locator unit 142 is capable to automatically receive locations of consumers' mobile devices 120 by using conventional data communication means according to various prior art techniques, such as determining the U-TDOA (Uplink Time Difference of Arrival), TOA (Time-of-Arrivals), AOA [Please define this abbreviation], E-OTD (Enhanced-Observed Time Difference), and using various prior art hybrid techniques, for example. It should be noted that, according to a further embodiment of the present invention, Locator unit 142 does not update the consumer's location if, for example: a consumer disables automatic mobile device positioning updates; a consumer did not update manually his position for a predefined period of time; a consumer disables identification of the communication connection (e.g., a consumer blocks cookies and the like); the consumer removes history of his past locations within the local market; etc.

According to an embodiment of the present invention, consumers 110 may receive substantially immediate, personal and relevant information by using context-aware services provided by system 100. These services comprise, for example: enabling to conduct a contextual local search; providing contextual recommendations (selected targeted content) to consumers; providing local market orientation and navigation services; providing online purchasing services; providing local market messaging services which enable consumers to exchange local market shopping targeted information, and other services. In addition, consumers are able to exchange information with advertisers, and vice-versa. Also, consumers are able to use these services prior and during their shopping journey by means of mobile devices 120.

It should be noted that, according to an embodiment of the present invention, mobile device 120 of each consumer may have at least the following capabilities: (a) is able to connect to a data network 148 (such as the (mobile) Internet, WLAN (Wireless Local Area Network), etc.); (b) is able to use substantially real-time remote services provided by system 100; (c) is able to display and/or play corresponding textual data, images, video and audio data, and the like. In addition, each mobile device 120 may comprise (or may be connect at any way) one or more of the following units/systems: outdoor/indoor positioning unit 121 (such as the GPS) for enabling providing substantially real-time consumer's mobile device 120 location to system 100; accelerometer 121 for measuring consumer's acceleration and thereby enabling determining his movement within the shopping facilities; Voice Recognition software (SW) 123 for enabling to provide voice commands; RF (Radio Frequency) Tag Reader/Transceiver 125 for enabling acquiring RF tag data being related to various local market information; Camera 126 and Visual Tag Image Processing Software (SW) 124 for enabling capturing and processing predefined visual tags being related to various local market information. It should be noted that the consumer's mobile device is able to send or receive email, SMS (Short Message Service)/MMS (Multimedia Messaging Service) messages or any other textual/multimedia data over data network 148.

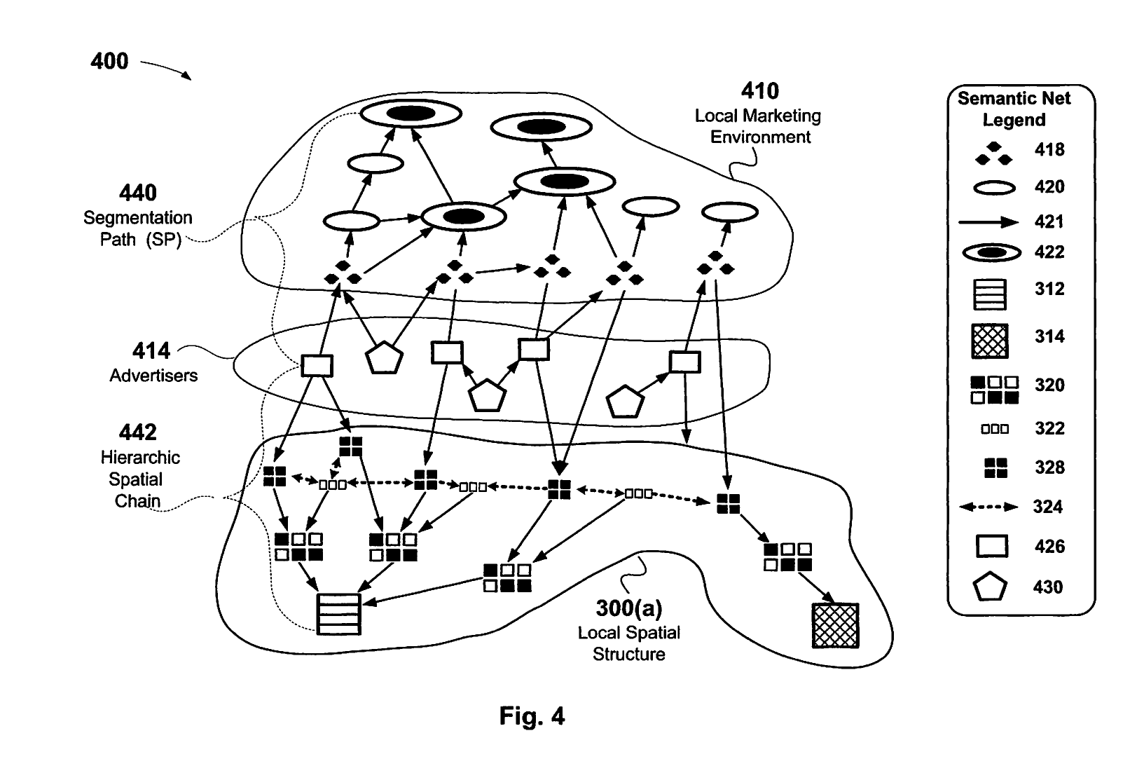

According to an embodiment of the present invention, system 100 enable advertisers 111 to manage online targeted campaigns at one or more local markets. According to another embodiment of the present invention, system 100 is capable to supports local advertisers 426 (FIG. 4) as well as global advertisers 430 (FIG. 4).

According to another embodiment of the present invention, system 100 is capable to support various types of advertisers, such as for example local point of sales, local retailers; local entertainment businesses; local food and drink businesses; local restaurants; local bars; local coffee shops; local brands; local market operators; other local businesses which are located in the local market; other businesses which are interested in targeted marketing messages to be sent to particular local consumers; and the like.

According to still another embodiment of the present invention, each subscribed advertiser device 126 may have one of the following capabilities, for example: (a) is able to connect to data network 148; (b) is able to conduct online advertiser's remote services, provided by system 100, over said data network 148 by using either a mobile device 120 or immobile device (not shown); and (c) is able to display and/or play textual data, images, video and audio data, and the like. It should be noted that, according to an embodiment of the present invention, the online remote services provided by system 100 enable the subscribed advertisers 111 to upload contextual targeted information to the system 100 (for example, to Contextual Information Acquiring unit 156). Also, according to an embodiment of the present invention, each advertiser device 126 is capable to conduct and present targeted campaign performances analysis and reports.

According to still another embodiment of the present invention, each consumer's mobile device 120 connects to LMSC 101 by means of a remote consumer services apparatus 127, which operates as a network gateway. Similarly, each advertiser's device 126 connects to LMSC 101 by means of a remote advertiser services apparatus 128, which operates also as a network gateway. Thus, both the remote consumer services apparatus 127 and remote advertiser services apparatus enable connecting a plurality of consumers' mobile devices 120 and a plurality of advertiser devices 126, respectively, with regard to at least one LMSC 101. Generally, both remote consumer services apparatus 122 and remote advertiser services apparatus 128 enable performing the following operations: (a) managing data communication over a data network 148; (b) providing data communication security; and (c) providing data traffic balancing and other data processing operations.

According to a further embodiment of the present invention, both wire and wireless devices may communicate over data network 148, such as mobile and immobile Internet; Wide Area Network (WAN); Local Area Network (LAN); WLAN; (high speed) cellular communication network that use for example 3G (third-generation) protocols, 4G (fourth-generation) protocols, High-Speed Packet Access (HSPA), High-Speed Downlink Packet Access (HSDPA), High-Speed Uplink Packet Access (HSUPA), General packet radio service (GPRS), High Speed GSM, LTE; other wireless wide broadband protocol such as Wi-Fi (Wireless Fidelity), Municipal WiFi, MetroFi (offering Wi-Fi wireless access to municipalities), Muni Wi-Fi/Muni-Fi (Municipal wireless network), Wireless Access Zone (WAZ), WiMAX (Worldwide Interoperability for Microwave Access), etc. In addition, data network 148 enable using a plurality of services/data communication types, such as WEB-based services, email, SMS, MMS, Voice over IP (Internet Protocol), Video over IP, Positioning services, Secured Data services, etc.

According to still a further embodiment of the present invention, a system administrator 112 (not shown) may connect to at least one LMSC 101 (FIG. 1) over a data network 148 and perform, for example, the following operations: (a) upload local market maps and drawings; (b) define local market spatial data entities, which represent market buildings, shopping floors, parking floors, open spaces, spatial grid, and other market physical areas; (c) define cross-correlation between these spatial data entities; (d) allocate each market area/section to corresponding local market business entities; (e) maintain and bill subscribed advertisers accounts; (f) provide system 100 maintenance services; etc. In addition, system administrator 112 may connect to at least one remote consumer services apparatus 127 as well as to at least one remote advertiser services apparatus 128.

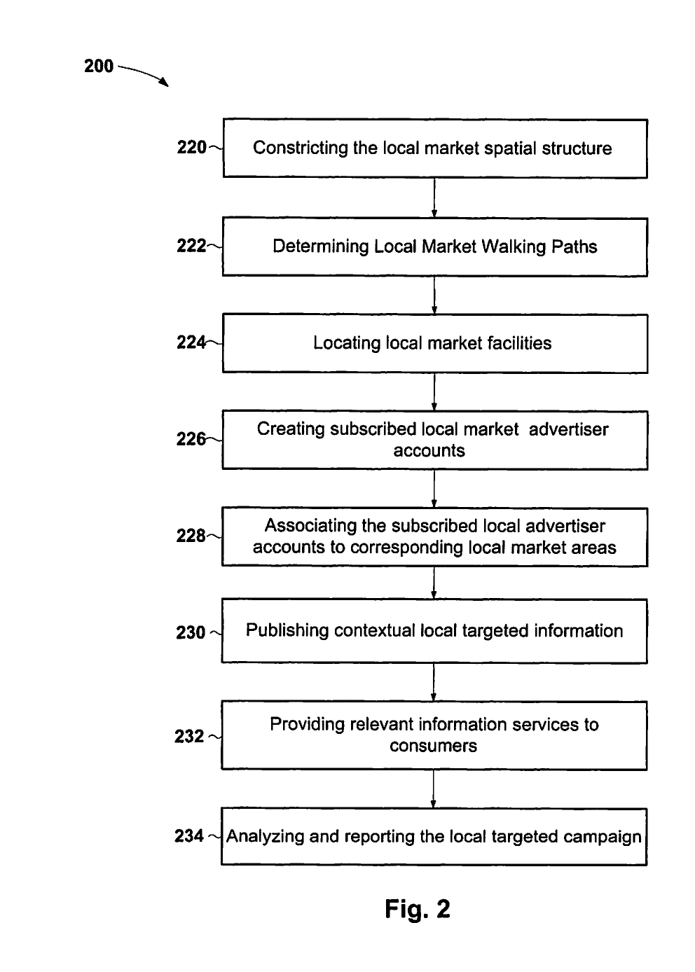

According to an embodiment of the present invention, the contextual targeted content provided by advertisers, as well as general information data (such as the local market spatial structure), are acquired and processed by means of Contextual Information Acquiring unit 156, as schematically presented by FIG. 2. Then, the acquired data is stored within local semantic database 160, giving rise to a local market semantic network 400, which is further presented in FIG. 4. Also, Contextual Information Acquiring unit 156 continuously updates local semantic database 160, thereby keeping local market semantic network 400 to date.

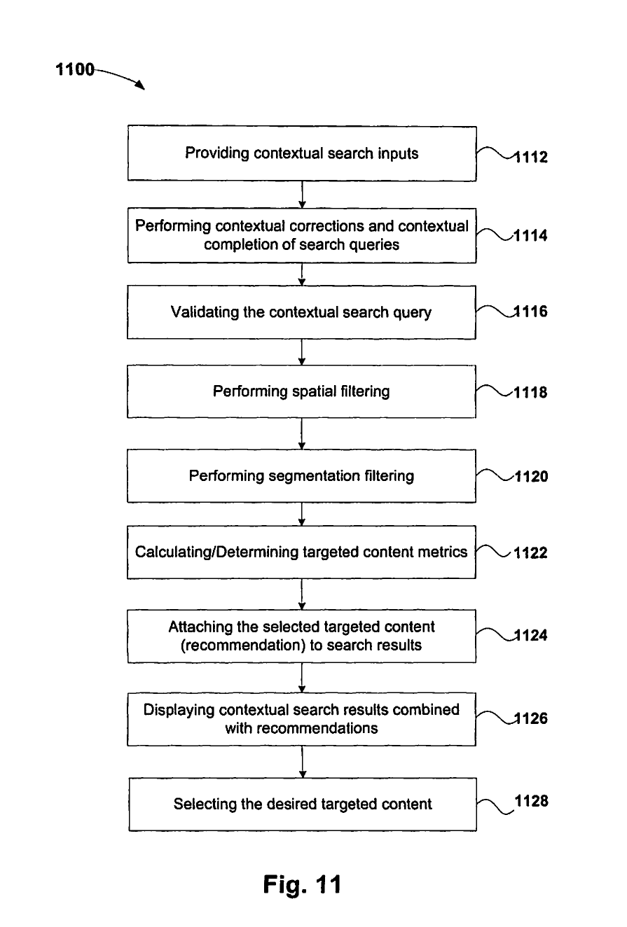

According to an embodiment of the present invention, consumer 110 who is looking for substantially immediate personal information, can be provided, substantially in real-time, with a contextual recommendation (according to his preferences), which in turn is provided by means of contextual recommendation unit 153. Thus, for example, a recommendation for particular women sport shoes may appear on a mobile device 120 screen of a particular consumer that is identified by system 100 both as interested in purchasing the women sport shoes and as located near a sale point of said particular women sport shoes. For another example, it is supposed that consumer 110 is looking for a particular local point of sale for purchasing children's clothes, and he queries contextual search engine 150 by using one or more search keywords, such as “child” and “clothes”. In turn, contextual search engine 150 may process the above consumer's search keywords by a method that is presented for example in FIG. 11. Further, in order to increase the relevancy of the content provided to the consumer, said contextual search engine 150 can use a contextual consumers' recommendations/preferences, which can be provided by Consumer Preferences Services unit 152, which processes and analyzes each consumer's behavior, giving rise to each consumer's personal/community preferences, which are further stored within preferences database 162.

According to an embodiment of the present invention, advertisers 111 can assess and control their targeting advertizing campaigns by means of Targeted Campaign Analyzing unit 154. For example, an advertiser may set a cost effective targeted campaign of a new product with regard to several targeted local markets. The targeted campaign analysis can be based on one or more local market consumers preferences, which are acquired and processed by one or more Consumer Contextual Preferences units 152 and stored by one or more consumers' preferences databases 162.

According to an embodiment of the present invention, targeted campaigns monetization can be based on measuring traffic of contextual information by counting specific (either direct or indirect) selections of particular consumers. For example, the measured traffic of particular sports shoes advertisement can be based on performing the following consumers' selection counts: a number of consumers who visit a related point of sale (it is noted that the consumer visit is considered as an indirect selection); a number of consumers information exchanges, such as a number of sent emails, SMS/MMS messages, with regard to the said sports shoes advertisement (it is noted that each sent message can be also considered as an indirect consumer selection of a particular product/service, for example); a number of consumers who purchased or wished to purchase a particular product/service (it is noted that this is considered an a direct consumer selection); etc.

It should be noted that since RF tag reader/transceiver 125 enables acquiring RF tags from products being sold by particular points of sale, and since visual tags are also associated with particular points of sale, then system 100 can determine physical location of a consumer (user) within the local market according to RF tags and/or visual tags, acquired by means of user's mobile device. In addition, it should be noted that RF tag reader/transceiver 125 and camera 126 can be either integrated within mobile device 120 or provided as external units/components. Further, it should be noted that according to another embodiment of the present invention, instead of mobile device 120, any other terminal can be used, such as a conventional personal computer (PC), or laptop, and the like.

FIG. 2 is a schematic flow-chart of a method 200 for deploying local market context-aware system 100 (FIG. 1), according to an embodiment of the present invention. According to this embodiment of the present invention, enabling local market context-aware system comprises , for example, the following steps: (a) constructing a local market spatial data structure at steps 220, 222, 224; (b) managing subscribed advertiser accounts at step 226; (c) associating the subscribed local advertisers to corresponding local market areas at step 228; (d) publishing contextual local targeted information at step 230; (e) providing substantially immediate, personal and relevant information services to a plurality of consumers at step 232 by means of one or more of the following: contextual local search, contextual shopping map, content exposure, and contextual recommendations (selected targeted content); and (f) analyzing and reporting local targeted campaign at step 234.

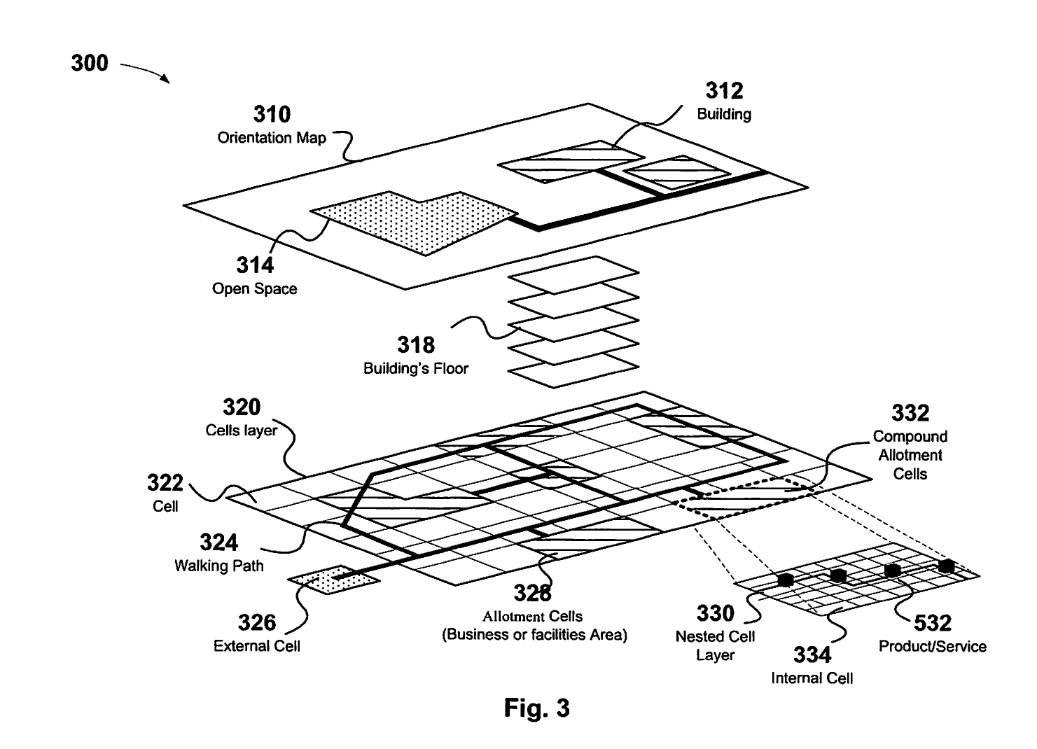

According to an embodiment of the present invention, at step 220, the local market spatial structure is constructed by means of contextual information acquiring unit 156 (FIG. 1). The local market spatial construction comprises: acquiring and processing local market maps and drawing as well as ascripting surface data layers, such as cell layer 320 (FIG. 3), to maps and drawings, which can be uploaded, for example, by a system administrator/operator (it should be noted that, according an embodiment of the present invention, the spatial structure construction process of one or more local markets can be conducted by one or more system administrators/operators (not shown) over a data network 148 (FIG. 1)).

According to an embodiment of the present invention, at step 222, the walking paths 324 (FIG. 3) can be determined (calculated) by means of contextual information acquiring unit 156 (FIG. 1). Generally, a walking path 324 is a path, which can represent any path type (e.g., the shortest path) between two predefined connectable market cells 322 (FIG. 3). The walking paths 324 may be periodically updated (e.g., once a month) due to possible changes in the market spatial structure. It should be noted that the determined walking paths 324 are used by system 100 to provide location-based services to consumers, assisting the consumers to estimate distances from each point of sale within the shopping facilities, and assisting said consumers to navigate within said shopping facilities.

According to an embodiment of the present invention, at step 224, plural local market service's facilities represented by system 100 data objects can be associated with spatial structure 300 (FIG. 3) objects. These local service facilities objects might represent, for example, shopping areas, parking spaces, automated teller machines, toilet zones, elevators, stairs, escalator and other plural local market facilities. For this, the system administrator may ascript these local facility objects, for example, to surface cells (e.g., allotment cells 328 (FIG. 3)) for representing corresponding local market areas, which are physically occupied by these objects.

According to an embodiment of the present invention, at step 226, the subscribed advertiser accounts can be created either automatically, (e.g., by means of system 100 online registration service initiated by an advertiser), or manually by means of system 100 administrators. The subscribed local advertiser 426 (FIG. 4) account can be related to one or more global advertisers 430 (FIG. 4) accounts, and vice-versa. According to another embodiment of the present invention, advertiser accounts' data are stored in advertiser database 163 (FIG. 1).

According to an embodiment of the present invention, at step 228, the subscribed local advertiser account might be related to one or more local market spatial structure 410 objects (FIG. 4). For this, either the advertiser 111 or the system administrator associates the areas, which are occupied by objects, to corresponding surface cells (allotment cells 328). As a result, the subscribed local business can be contextually become associates (by means of system 100 context-aware services) to particular areas at the local market space, and vice-versa.

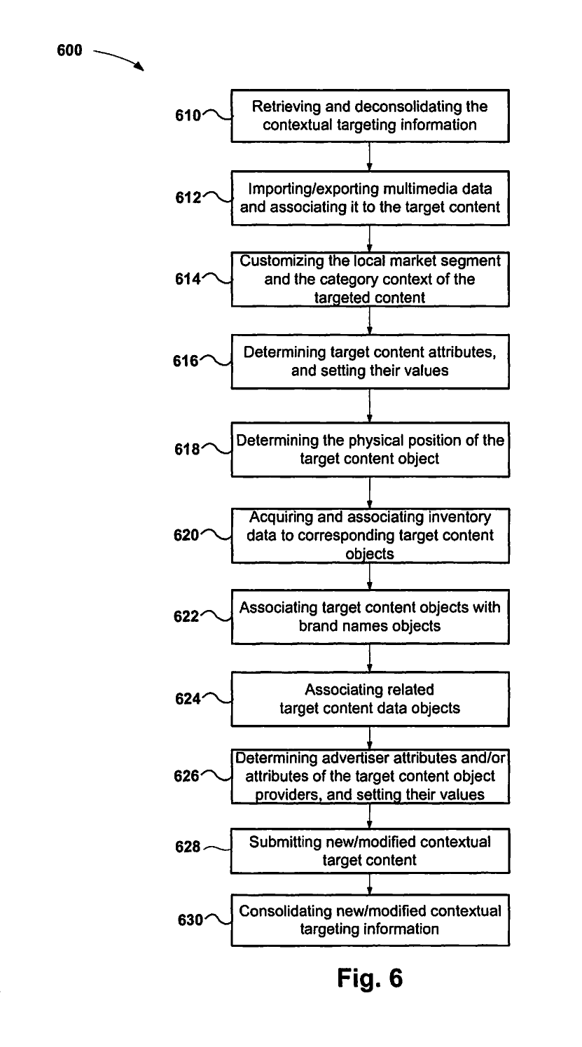

According to an embodiment of the present invention, at step 230, the subscribe advertisers are able to publish online contextual target content (FIG. 6) over a data network 148 (FIG. 1) by means of contextual information acquiring unit 156 (FIG. 1). The contextual target content is represented by data object, which can be related to product/service advertisement, sale promotion message or any other local information, which can be provided by the advertiser substantially in real-time. In addition, the contextual data that may comprise: physical location, market segment and categories, attributes, and other environmental factors can be related to the targeted content as well. It should be noted that, according to an embodiment of the present invention, system 100 enables the subscribed advertisers to customize their target content data as well as the contextual data, such as target market segments, location, related brands, and the like. Also, it should be noted that according to an embodiment of the present invention, the publishing step 230 involves not only a publication of the content but also a publication of the context (of targeted content), such as: market segments and categories, which relate to the published content; location of the content objects (e.g., product/service points); providers of content objects and their location in the local market space; and attributes of the content objects.

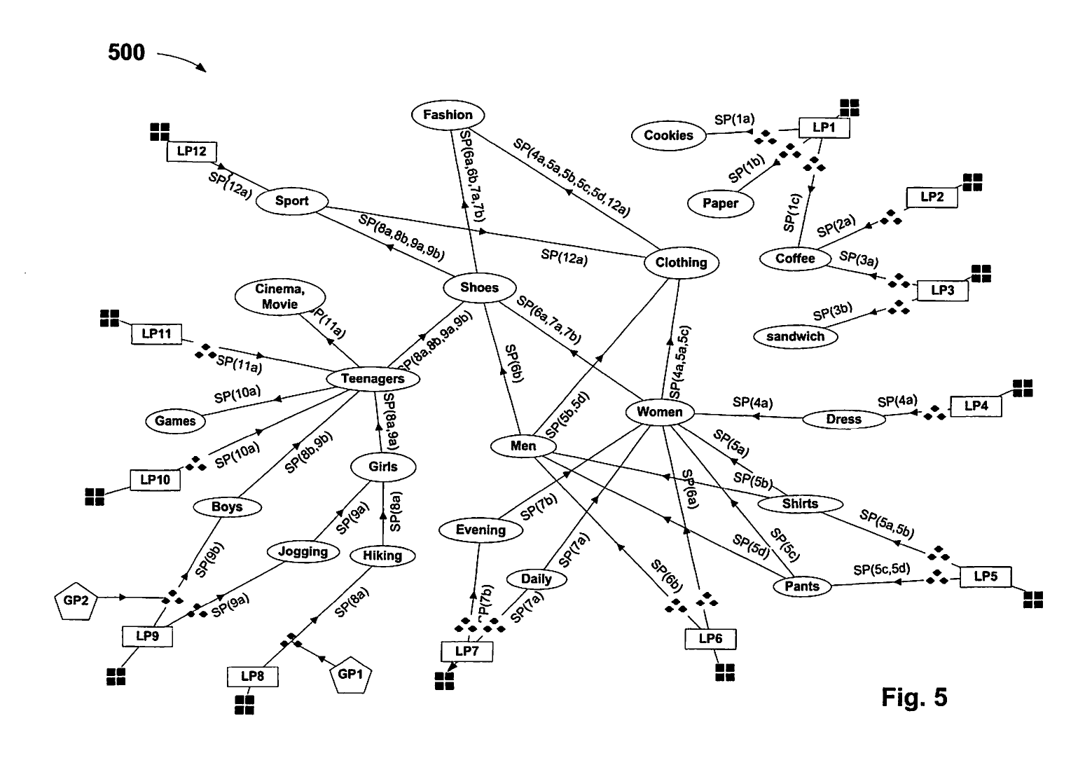

For example, it is supposed that a local advertiser “LP7” (FIG. 5) wishes to advertise women's evening shoes by using system 100. For this, said local advertiser subscribes to system 100, and then he is able to publish his targeted advertisement(s) of the shoes being sold. In turn, the shoes advertisement(s) is exposed to the target consumer(s), based on relevancy ranks, which are determined by system 100. According to an embodiment of the present invention, these targeted consumer (and their corresponding preferences) can be determined, amongst others, according to the context aware local targeted content (LTC) provided by each advertiser. Such contextual data can be represented, for example, by one or more category chains (e.g., the chain such as “fashion”->“shoes”->“women”->“evening” (FIG. 5)), representing the category segmentation of the target market.

According to an embodiment of the present invention, at step 232, the local consumers are enable to pull substantially immediate (substantially real-time), personal and relevant information by using predefined services of system 100 (i.e., by actively interacting with the consumers), such as performing local search by means of search engine 150, using a shopping map provided by means of shopping map unit 143, using the content exposure unit 145 for receiving desired content, etc. Thus, the consumers can be provided with corresponding selected targeted content substantially in real-time. This selected targeted content is further dynamically updated according to consumer's activities with regard to the predefined physical site (a shopping mall) and according to dynamic semantic network 400 (FIG. 4). It should be noted that semantic network 400 can be also continuously updated by a plurality of advertisers.

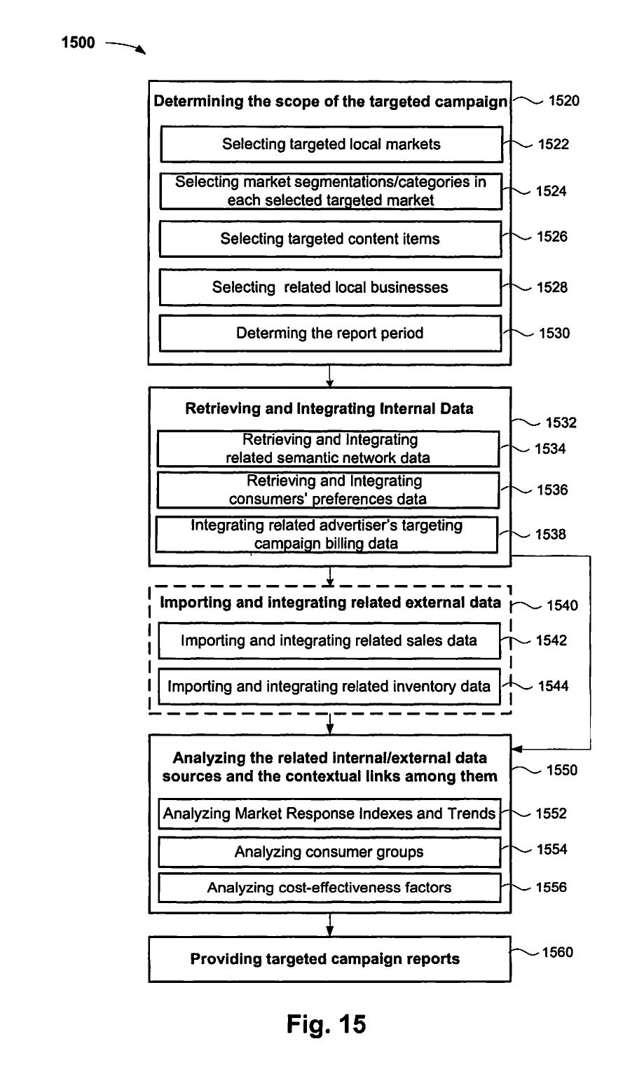

Further, at step 234, the system 100 is able to provide advertisers with targeted campaign reports based on the analysis of data with regard to semantic network 400 objects (FIG. 4) and with regard to consumer's contextual preferences data (as presented in FIG. 15). It should be noted that the above analysis and the generating of the above reports is performed by means of targeted campaign analyzing unit 154 (FIG. 1).

FIG. 3 is a sample schematic illustration of a local market spatial structure 300, according to an embodiment of the present invention. It should be noted that one of the main key factors, which can significantly increase the relevancy of content (e.g., search results, target advertisements) provided to a consumer, is the location of content objects (e.g., products) and/or the location of a consumer. This can have a significant importance especially for consumers, who are in a hurry and/or are looking for a nearly-located point of sale, which sells desired products or provides desired services. In addition, the location-based awareness may be essential for consumers who have difficulties in determining targeted points of sale and/or have difficulties in navigating through relatively large markets.

According to an embodiment of the present invention, local market spatial structure 300 comprises, for example, market orientation map 310 (e.g., associated with a corresponding digital image), which represents the texture of the overall market area. In turn, the orientation map 310 may be associated with at least one of the following objects such as building objects 312 which are associated with one or more building's floor objects 318; and open space objects 314 within the market area. In turn, building's floor object 318 may represent both shopping regions (containing one or more points of sale) and non-shopping regions (e.g., parking floors, staircases, and the like). Also, cell layer 320 is associated with both open space objects 314 and building's floor object 318, and it contains a plurality of cell objects 322, each having a predefined physical dimension (as predefined, for example, by an administrator of system 100 (FIG. 1)). Each cell object 322 can be defined as a spatial object, which represents a relatively small region of each floor, and which may contain one or more physical entities (e.g., one or more product locations) within the market area.

Further, the cell path that relates to a group of adjacent cell objects 322, thereby representing a path between connectable cell objects 322, defines walking paths 324. In addition, each external cell 326 is a cell which physically resides in external cell layer 320 that is located out of the market area (e.g., a bridge between buildings). Also, the allotment cell 328 is a cell, which can be associated with local advertiser 426 (FIG. 4) areas or other general services facilities (e.g., staircases). Further, nested cell layer 330 is a layer that represents a relatively large local advertiser 426 (FIG. 4) internal area, and is associated with compound allotment cells 332, which in turn can be associated with said local advertiser 426 targeted content representing corresponding products or services 532. The targeted content provided by said local advertiser 426 can be also associated with one or more internal cells 334 (having predefined dimensions), which are also located within the nested cell layer 330.

FIG. 4 is a sample schematic network diagram of a general local market semantic network 400, according to an embodiment of the present invention. It should be noted that semantic network 400 represents “local market factors” (such as market segments, market categories, advertisers, spatial structure of the market, market facilities, etc.) along with logical connections between the related factors.

According to this embodiment of the present invention, local market semantic network 400 is defined as a graph structure, containing a plurality of nodes (such as points of sale, product/service categories, shopping areas, etc.) along with related connections (links), defining contextual relations between these nodes. This structure is stored within a local market semantic database 160 (FIG. 1), and is used to preserve (and in turn, to retrieve) local targeted contents (LTC) along with the related contextual information.

According to this embodiment of the present invention, semantic network 400 comprises: (a) local marketing environment group 410 objects consisting of one or more segments, wherein each segment is represented by one or more local market categories objects (420, 422) chains. In turn, each chain is related to one or more local targeted content objects 418; (b) local spatial structure group 300(a), which is determined by local market spatial structure 300 (FIG. 3); (c) local and global advertisers group 414, which represents targeted content advertisers (such as point of sale providers, service providers, product providers, advertising campaign providers, etc.) who advertise their products, services, and the like, which in turn are related directly or indirectly to semantic network 400. It should be noted that local market semantic network 400 is an outcome of system 100 that deploys a method, which is presented in FIG. 2 and is performed be means of contextual information acquiring unit 156 (FIG. 1) at each target local market (e.g., each shopping mall).

According to an embodiment of the present invention, local marketing environment group 410 comprises the following objects: (a) local targeted content data objects 418, which can represents products/services digital advertisements, sale promotion message, and any general information that can be provided to target consumers; (b) category objects 420, wherein each category object is defined by at least one word/term (e.g., “coffee”), identifying the targeted content object category by directed contextual link 421; (c) common category objects 422, wherein each common category contains at least one association to the corresponding category objects 420.

For example, in FIG. 5, which is a schematic illustration of a particular local market semantic network instance 500, according to an embodiment of the present invention, the common category object represented by the term “coffee” is related to the targeted content of products, services, or general information, which is targeted by local advertisers 426 (FIG. 4): “LP1”, “LP2”, “LP3” (in FIG. 5, it is supposed, for example, that semantic network 500 of a particular local market contains twelve local advertisers denoted as: “LP1”, “LP2” . . . “LP12” (which in turn gives rise to at least twelve segmentation paths (SPs), such as SP(1a), SP(2a), SP(12a)) and two global advertiser denoted as “GP1” and “GP2”). It should be noted that local advertisers are local businesses (e.g., points of sale) that are located at the local market area and manage online targeted campaigns by means of system 100 (FIG. 1). It should be noted that, according to an embodiment of the present invention, local advertiser 426 can be related to local point of sales, local services provider, local information provider, and any other type of local business which sales/provides any commercial/noncommercial product, services, goods or any information for local market consumers. On the other hand, global advertisers 430 (FIG. 4) are businesses that manage online targeted campaigns by means of system 100 although they are not physically located within the local market area. According to an embodiment of the present invention, global advertisers 430 can be associated directly to targeted content information by brand (name) relations. In addition, global advertisers 430 can be associated to local advertisers 426, which provide product/services that are related to the global advertiser targeted campaign information.

According to an embodiment of the present invention, the local spatial structure group 300(a) represents the physical structure of the local market and local spatial information as well. Generally, spatial group 410 comprises the following market spatial objects: (a) buildings 312 (FIG. 3); (b) open spaces 314 (FIG. 3); (c) cells layers 320 (FIG. 3); (d) cells 322 (FIG. 3); (e) allotment cells 328 and 332 (FIG. 3); and (f) walking paths 324 (FIG. 3). The local spatial structure group 410 elements are connected by directed contextual links 421 which define the structured relations among them. According to another embodiment of the present invention, advertiser group 414 cross-connects (integrates) the local market physical regions (defined within the spatial group 410) with the corresponding local marketing environment of the local targeted content (defined within local marketing environment group 410) by means of directed contextual links 421. The advertiser group 414 comprises: (a) local advertiser business objects 426; and (b) global advertiser objects 430.

In general, market targeting is a process of selecting a market segment to address a corresponding consumer. According to an embodiment of the present invention, a segmentation path 440 object, such as a segmentation path object 440′ (FIG. 6B), represents the segmentation context of targeted content object 418 (local product or service) as well as the segmentation context of each advertiser objects (local and global advertiser object 426, 430 respectively). According to an embodiment of the present invention, segmentation path 440 object is associated with the following semantic objects consisting, for example, of (a) at least one advertisers object (local advertiser 426 and/or global advertiser 430); (b) at least one target content data object 418; (c) at least one category objects 420 or common category objects 422; (d) directed contextual links 421, which connect these objects in a predefined order based on these object types, for example: 426, 418, 420, 422 as shown in FIG. 5. In addition, it should be noted that each advertiser object (426/430) can be associated with more than one segmentation path in case it relates to more than one local market segment. In FIG. 5, for example, local provider “LP7” is associated with the following segmentation paths: SP(7a) and SP(7b), which represent products that are related to the following local market segments {“fashion”->“shoes”->“women”->evening”}, {“fashion”->“shoes”->“women”->day”}, respectively.

In addition, according to an embodiment of the present invention, a target content data object 418 can be associated with one or more segmentation paths 440. Similarly advertiser 426 and/or global advertiser 430 can be associated with one or more segmentation paths 440 as well.

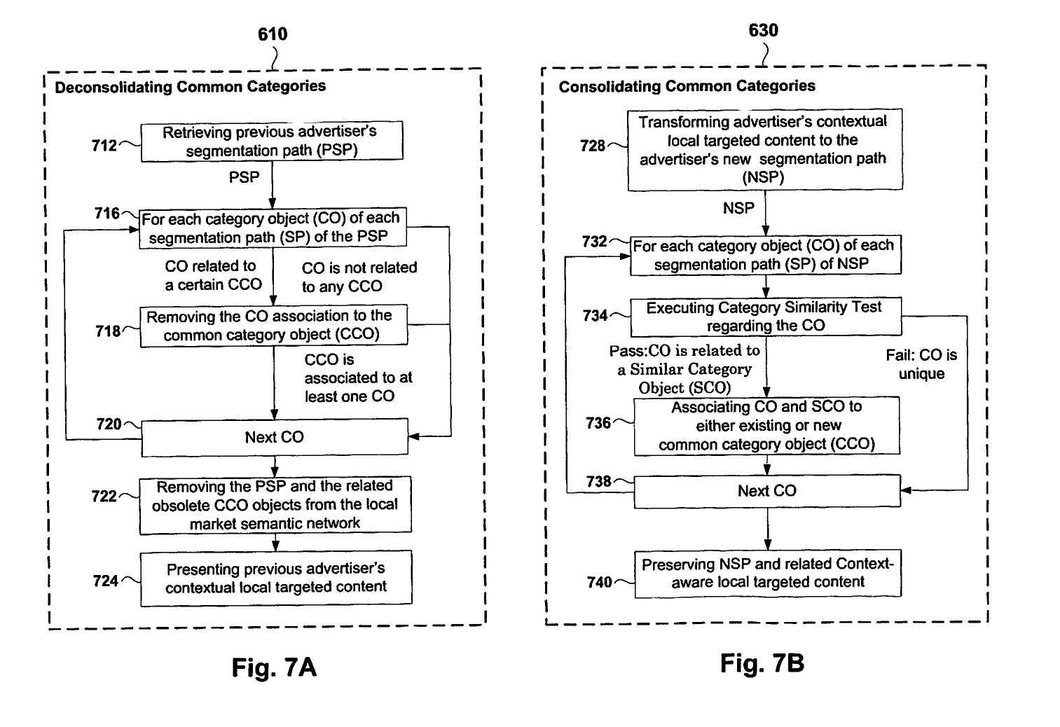

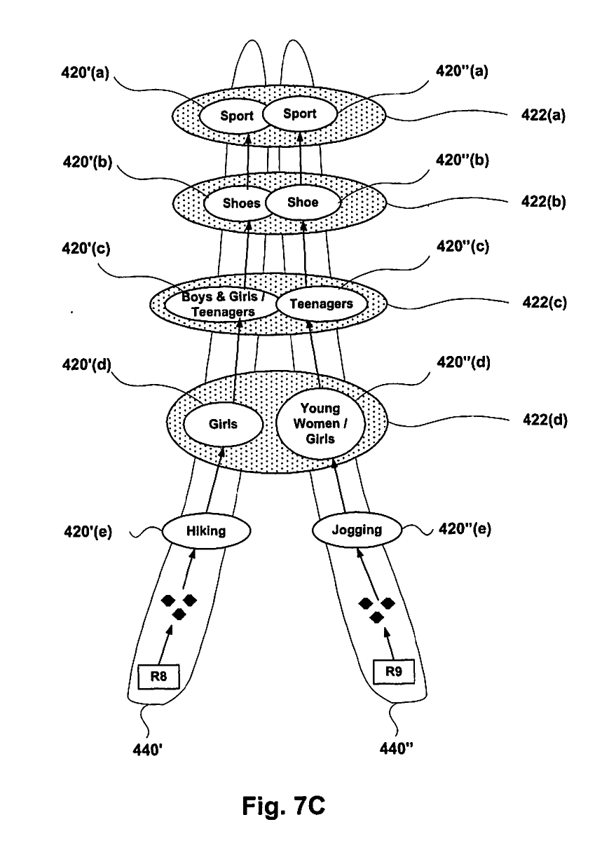

Also, according to an embodiment of the present invention, category objects can be associated with segmentation paths 540 as follows: (a) each category object 420 (FIG. 4) is associated only with a single segmentation path (SP) 440 such as a segmentation path object 440′ (FIG. 7B); and (b) each common category object 422 (FIG. 4) is associated with more than one segmentation path. In FIG. 5, for example, the category object which represents “women” should be consider as common category 422 object because it is associated with multiple SPs comprising of: SP(4a), SP(5a), SP(5c), SP(6a), SP(7a), and SP(7b). However, the category object which represents “dress” should be consider as category object 420 because it is associated with a single SP=SP(4a).

According to an embodiment of the present invention, hierarchic spatial chain (HSC) object 442 (FIG. 4) represents spatial context of local advertiser object 426 (FIG. 4) or local targeted content (LTC) data object 418 (FIG. 4). The spatial chain 442 (FIG. 4) may comprise: (a) either a single local advertiser object 420 or a single LTC data object 418; (b) at least one allotment cell object 328 (FIG. 3); (c) a single cell layer object 320 (FIG. 3); (d) either a single building object 312 (FIG. 3) or a single open space object 314 (FIG. 4); (e) directed contextual links 421 (FIG. 4), which connect these objects in a predefined order based on these object types, for example: 426/418, 328, 320, 312/314 as shown in FIG. 5. Thus, as an example of a hierarchic spatial chain, local advertiser “LPa” (not shown) can be located in cell “C1” (not shown) of cell layer 320, which in turn is associated with “Floor 1” of “Building B” (not shown) of predefined local market area “M” (not shown); and product “P” is located in cell “C2” (not shown), which belongs to cell layer 320 that contains local advertiser “LPb” and associated with “Floor 2” of “Building A” (not shown). It should be noted that that a single local advertiser object 426 can be associated to one or more hierarchic spatial chain (HSC) object 442, which represents one or more shopping areas related with this local advertiser object

According to an embodiment of the present invention, semantic network 400 (FIG. 4) is used by Locator unit 142 (FIG. 1), which is capable to synchronize consumer mobile device locations with regard to local spatial structure 300 (FIG. 3) objects and vice-versa. In addition, according to an embodiment of the present invention, semantic network 400 can be used by local market contextual search engine 150 (FIG. 1) to provide substantially immediate, personal and relevant content to consumers of the local market. Similarly, according to an embodiment of the present invention, semantic network 400 can be used to locate relevant information by Contextual Shopping Map unit 143 (FIG. 1) as well as to associate targeted content displayed by Contextual Local Content Exposure unit 145 (FIG. 1).

Moreover, according to another embodiment of the present invention, semantic network 400 can be used by Consumer Contextual Preferences unit 152 (FIG. 1) to transform consumer selection, which can be identified by system 100, to one or more corresponding consumer preferences by using semantic network 400 objects and context-aware links. Similarly, according to an embodiment of the present invention, the recommendation analysis performed by means of contextual recommendation unit 153 uses semantic network 400 data. Further, the semantic network 400 can be used by the targeted campaign analyzing unit 154 (FIG. 1).

It should be noted that a personal recommendation to be provided to a consumer can be, for example, at least one of the following: (a) an advertisement being related, directly or indirectly, to the predefined semantic network; (b) a link to an advertisement; (c) a coupon; (d) a voucher; (e) a promotion; (f) a local marketing information being related to the predefined semantic network; (g) an information related to a product provided within the predefined physical site; (h) an information related to a service provided within the predefined physical site; (i) an information related to a brand provided within the predefined physical site; (j) an information related to a point of sale provided within the predefined physical site; and (k) an information related, directly or indirectly, to the predefined physical site. Also, it should be noted that each node of a segmentation path (such as segmentation path 440′) can be a category (e.g., “clothing”) or a sub-category (e.g., “shoes”), thereby being indicative of at least one semantic network 400 (FIG. 4) element.

FIG. 6 is a schematic flow-chart 600 of a method for publishing the contextual local targeted content, according to an embodiment of the present invention. At step 610, after a particular subscribed advertiser device 126 (FIG. 1) connects to system 100, then the advertiser's targeted content (as well as related contextual data) is retrieved from semantic network database 160 (FIG. 1). In turn, system 100 performs category deconsolidation with regard to said retrieved data, according to category deconsolidating step 710 (FIG. 7A). Finally, the targeted content is presented to the advertiser by contextual target content editing interface (not shown), which may be presented on said advertiser's device 126.

According to an embodiment of the present invention, at step 612, system 100 enables advertisers to import/export multimedia data (such as multimedia advertisements) from/to a plurality of external sources, such as external online systems, plural digital media formats (containing textual formats), graphic formats, video formats (e.g., MP4 (MPEG-4 (Moving Picture Experts Group) Part 14) format), audio formats (e.g., MP3 (MPEG-1 Audio Layer 3) format), or any combination of these media formats, and the like. In addition, system 100 enables the advertiser to associate this multimedia data to local targeted content object 418 (FIG. 4) by means of the contextual target content editor interface (not shown), which can be presented on the advertiser's device 126.

According to another embodiment of the present invention, at step 614, system 100 enables advertisers to customize online the corresponding local market segments (such as “sport shoes”, etc.) and categories context of the targeted content by means of the contextual target content editor interface. For example, a sport shoes advertisement can be related to the “teenagers sport shoes” segment. In such a case, said sport shoes advertisement will be presented to the potential teenager consumers. According to an embodiment of the present invention, the market segmentation of the targeted content can be determined by category chains, wherein each category may contain one or more word/terms defined by the advertiser.

According to still another embodiment of the present invention, at step 616 system 100 enables advertisers to determine a plurality of attribute types (such as color, size, price) as well as setting their values and associating them with the corresponding target content data object(s) 418 (FIG. 4). These attribute types enable the advertiser to position the content object into a corresponding target market segment (i.e., differentiating products/services from similar objects in the target segment). For example, a advertiser, who provides advertisement related to the term “sport shoes” for teenager consumers, can differentiate between different sport shoes according to the shoes “size” attribute, unique “color” attribute, “cost” attribute, and the like. It should be noted that this step can be also executed by the advertiser by using the contextual target content editor interface (not shown), which can be presented on advertiser's device 126. In addition, at step 616, according to another embodiment of the present invention, subscribed advertisers are able to associate their predefined keywords with the corresponding local targeted content in order to increase the ability to reach their target consumers. Generally, these keywords can be divided into primary category keywords and secondary category keywords in order to differentiate major keywords from minor keywords (the minor keywords may be related, directly or indirectly, to the corresponding major keywords). For example, if an advertiser wishes to designate his advertisement, related to “sports shoes”, to “teenager girls” (the primary category keywords), then the advertiser may also wish to associate his advertisement with the term “young women” (the secondary category words).

At step 618, according to still another embodiment of the present invention, system 100 enables advertisers to determine a physical position of the target content object (e.g., a product/service) with regard to the spatial structure 300 (FIG. 3) of the predefined local market. For example, a consumer who is exposed to targeted advertisements related to the term “sport shoes”, can determine a physical location of the shop that sells the shoes by navigating over a local market map, which can be presented on his mobile device 120 and is associated (by system 100) with the positions of products being advertised. It should be noted that this step also can be performed by the advertiser by using the contextual target content editor interface (not shown), which can be presented on the advertiser's device 126. Further, at step 620, system 100 enables advertisers to acquire and associate inventory data (if exists) to corresponding targeted content by means of said contextual target content editor interface. The inventory data can be acquired either automatically (e.g., by connecting to external data sources related to the providers of the corresponding content objects), or manually. For example, products which are temporary not available will not be exposed to the consumer.

At step 622, according to still another embodiment of the present invention, system 100 enables advertisers to associate brand names (if exist) with the corresponding target content (according to related keywords/terms) by also using the contextual target content editor interface. In turn, this contextual relation can assist consumers to get information regarding a particular product/service category or segment with regard to particular brand name. In addition, this contextual relation is also useful for brands that wish to obtain local market response information (local market metrics) regarding a particular product or service.

At step 624, according to a further embodiment of the present invention, system 100 enables advertisers to associate two or more related target content data object 418 (FIG. 4) also by using, for example, the contextual target content editor interface. Thus, for example, a targeted advertisement with regard to “sport shoes” can also be related to a digital coupon for obtaining a discount for these sport shoes. As a result, the consumer who is exposed to the advertisement with regard to “sport shoes” may be also exposed to the corresponding coupon, which in turn may increase a probability to purchase the shoes (or any other advertised items).

At step 626, according to still a further embodiment of the present invention, system 100 enables advertisers to determine general attributes, such as telephone numbers of points of sale, opening hours, Web site addresses/URLs (Uniform Resource Identifiers), email addresses, and the like, also by using the contextual target content editor interface, for example.

At step 628, according to still a further embodiment of the present invention, the advertiser submits new/modified contextual target content, and, in turn, at step 630, system 100 consolidates the new/modified contextual targeted information.

According to an embodiment of the present invention, the amount of local market segmentation paths (such as segmentation paths 440′, 440″ (FIG. 7C) and the like) within the semantic network 400 (FIG. 4) can be significantly reduced. Also, it should be noted that the consolidation of one or more nodes of each segmentation path (such as segmentation paths 440′ and 440″ (FIG. 7C)) can be performed, for example, with regard to the following criteria: a) a typo error (e.g., two or more nodes relate to the same category, which is misspelled); b) a marketing filtering for filtering two or more similar market segments/fields; c) a praise words usage (e.g., “super”, “ultra”, and the like). For example, it is supposed that semantic network 400 (FIG. 4) contains twelve following segmentation paths:
Sport->Shoes->Boys;
Sport->Shoes->Male Child;
Sport->Shoes->Son;
Sport->Shoes->Young Male;
Gym->Shoes->Boys;
Gym->Shoes->Male Child;
Gym->Shoes->Son;
Gym->Shoes->Young Male;
Athletics->Shoes->Boys;
Athletics->Shoes->Male Child;
Athletics->Shoes->Son; and
Athletics->Shoes->Young Male.

Thus, according to an embodiment of the present invention, the categories “Sport”, “Gym” and “Athletics” can be consolidated into a single common category objects 420 (FIG. 4). Similarly, the categories “Boys”, “Male Child”, “Son” and “Young Male” can also be consolidated into another common category objects 420 (FIG. 4). As a result, there is only one category (which is still another common category object 420) that interconnects the above two different common category objects, and it is the category “Shoes”. By this way, the local market segmentation paths can be significantly reduced by consolidating two or more categories/sub-categories.

In addition, it should be noted that the segmentation paths can be also removed from semantic network 400 in one or more of the following cases: a) the segmentation paths are not used for a predefined period of time; b) the segmentation paths are determined as redundant; and c) the segmentation paths are determined as non-effective.

According to an embodiment of the present invention, the process of consolidating segmentation paths dramatically improves the performance of retrieving the relevant information, thereby further enabling to retrieve said relevant information in a relatively accurate and immediate way. FIGS. 7A and 7B are schematic flow-charts of category deconsolidating method 610 and category consolidating method 630, respectively, according to an embodiment of the present invention. According to this embodiment of the present invention, said consolidating/deconsolidating methods 610 and 630 enable associating/disassociating similar category objects 420 (FIG. 4) of the semantic network 400 (FIG. 4).

According to an embodiment of the present invention, the category consolidation can be preformed between two categories objects, which are considered as similar according to a category similarity test. For example, there can be two definitions of the category similarity test: the first definition can be used when both category objects are not common category 422 (FIG. 4) object; and the second definition can be used when one of the category objects is category object 420 (FIG. 4) and the other are common category 422 objects. According to the first definition, the two category objects 420, denoted for example by CO₁ and CO₂, are similar if one of the following criteria are fulfilled: (a) each of the primary category words of CO₁ are either identical, or similar, or are synonyms (according to any conventional text-comparison functions, or according to any (dictionary) word relations, or according to any conventional word similarity method/algorithm), to either at least one primary category word of CO₂ or to at least one secondary category word of CO₂; and (b) vice-versa. According to the second definition of the category similarity test, the category object CO₁ 420 and the common category object (CCO), are similar if the following criterion are fulfilled: the category object CO₁ and the at least one another category object associated with CCO are considered as similar according to the above first definition of the category similarity test.

According to an embodiment of the present invention, the category deconsolidation is defined as separation of consolidated categories, thereby disassembling common category objects 420 (FIG. 5). At step 712, the previous advertiser's segmentation path (PSP), which represents the context of the previous advertiser's targeted content (stored in advertiser's database 162 (FIG. 1)), is retrieved with other related data objects by means of acquiring unit 156 (FIG. 1) from local market semantic network database 160 (FIG. 1). Then, at step 716, each category object (CO) 420 of each segmentation path (SP) (such as the segmentation path 440′ (FIG. 7C)) of said PSP is iterated. If said CO isn't related to any common category object CCO 422 of the local market semantic network 400 (FIG. 4), then next CO iteration of the currently iterated SP of said PSP is selected at step 720; otherwise the currently iterated reference to the CO is removed from the said CCO at step 718. It should be noted that at step 720, the next CO is selected; otherwise the PSP iterations are ended as well as the deconsolidation of the PSP category objects. At step 722, the PSP and the related obsolete CCO objects (which are CCO that are not related to any CO), are removed from the semantic network 400 (FIG. 4). Then, at step 724, the previous contextual target content (if such content exists) is presented to the advertiser by means of the contextual target content editor interface.

According to an embodiment of the present invention, an outcome of the consolidation method 630 of consolidating two or more similar category objects 420 is a single common category object 422, which contains references of said two or more similar category objects 420 (FIG. 4). For example, as further schematically presented in FIG. 7C, if category objects 420′(d)=(“Girls”) and 420″(d)={“Young Women” (Primary category)/“Girls” (Secondary category)}, [Why? Please explain.], then said category objects 420′ (a) and 420″(d) are considered to be similar upon executing the category similarity test. As a result, the common category object 422 contains references to both category object 420′(a) as well as to the category object 420″(d). For another example, if category objects 420′(e)={“Hiking”} and 420″(e)={“Jogging”}, then said category objects 420′(e) and 420″(e) are not considered to be similar by executing a category similarity test. In such a case, no common category 422 can be associated to these category objects.

According to an embodiment of the present invention, at step 728, the new/modified contextual local target content data, provided by the advertiser, is processed and transformed to the advertiser's new/modified segmentation path(s) of semantic network 400 (FIG. 4), which comprises local targeted content objects 418 (FIG. 4); category objects 420; common category objects 422; directed contextual links 421, which connect the local marketing environmental objects 410 (FIG. 4) to the corresponding local advertiser's object 426 (FIG. 4). This process yields generation of at least one new segmentation path (NSP), such as segmentation path 440′ (FIG. 7C), which represents a new or reconstructed segmentation of the published local targeted content provided by the advertiser. Then, at step 732, each category object (CO) 420 of each segmentation path (SP) of the new segmentation path is iterated. After that, at step 734, a similarity test is executed with regard to the CO. If said CO passes the similarity test, which means that the CO is related to at least one Similar Category Object (SCO), then both CO and SCO are associated to Common Category Object (CCO) 422 at step 736; otherwise, the CO is considered to be unique, and in such a case step 738 is executed. It should be noted that a new CCO 422 is created in a case when the SCO is not initially associated with the existing CCO. Thus, at step 738, the next CO is selected; otherwise, the NSP iterations are ended as well as the consolidation of NSP category objects. Further, at step 740, the category consolidation outcomes as well as the new/modified contextual targeted content are preserved in the corresponding semantic network database 160 (FIG. 1).

FIG. 7C is a schematic illustration of a sample category consolidation, according to an embodiment of the present invention. It is assumed for example, that there are two segmentation paths 440 (FIG. 4): SP 440′ and SP 440″. SP 440′ represents a new segmentation path, and SP 440″ represents an already existing segmentation path (e.g., which is already constructed by other advertisers). In addition, it is assumed that the advertiser uses the system services at the first time, i.e the advertiser does not have any prior published data preserved in system 100. For example, the advertiser can submit both targeted content and local market context (such as categories, location and attributes). As a result, the SP 440′ is created by system 100. At step 732 (FIG. 7B), the first iteration (“iteration a”) is performed, and the first category object related to SP 440′ is selected: CO 420′(a)={primary: “sport”, secondary: φ}, wherein Φ represents an empty object. At step 734 (FIG. 7B), the category similarity text is executed with regard to CO 420′(a). As a result, an identical (similar) category object (SCO) is determined: SCO 420″(a)={primary: “sport”, secondary: Φ}, which means that the category similarity test is passed. At step 736, both CO 420′(a) and SCO 420″(a) are associated to common category object (CCO) 422(a), and the next COs are selected at step 738. Similarly to the last CO iteration, the following category consolidation iteration outcomes are generated: “iteration b”—CO 420′(b)={primary: “shoes”, secondary: Φ}, and SCO 420″(b)={primary: “shoe”, secondary: Φ} are consolidated and associated to CCO 422; “iteration c”—CO 420′(c)={primary: “boys & girls”, secondary: “teenagers”}, and SCO 420″(c)={“primary: “teenagers”, secondary: Φ} are consolidated and associated to CCO 422(c). It should be noted that the consolidation of CO=420′(c) and SCO=420″(c) involves secondary category words, according to the similarity test; “iteration d”—CO 420′(d)={primary: “girls”, secondary: Φ}, and SCO 420″(d)={primary: “young women”, secondary “girls”} are consolidated and associated to 422(d); “iteration e”—CO 420′(e)={primary: “hiking”, secondary: Φ} is identified by the similarity test as an unique category object, i.e there is no similar category object (SCO) which is related to C0=420′(e).

It should be noted that according to a further embodiment of the present invention, a weight value is assigned to at least one node (such as a category object) of each segmentation path (e.g., 440′, 440″, etc.), thereby enabling to provide at least one personal recommendation (selected targeted content) based on said weight. The weight values can be assigned and updated dynamically, according to a plurality of criteria/parameters, such as each consumer preferences, each consumer activity, advertisers' preferences, and the like. Also, it should be noted that by assigning the weight (values) to each segmentation path, the one or more relevant segmentation paths can be determined from a plurality of segmentation paths of semantic network 400 (FIG. 4), thereby enabling to provide personal recommendations to consumers with regard to said relevant segmentation paths. Also, the weight of each node can be dynamically updated with regard to at least one of the following: (a) a time period; (b) a physical location of a consumer; (c) a physical location of a point of sale (POS); and (d) a physical location of a point of interest, thereby enabling in turn to dynamically update the personal recommendation to be provided to the corresponding consumer. In another words, according to an embodiment of the present invention, the weight (value) of each node and/or of each segmentation path is a function of the at least one predefined parameter, which can be at least one of the following: (a) a consumer selection parameter; (b) a segmentation path parameter; (c) a category parameter; (d) a sub-category parameter; (e) a consumer identification number parameter; (f) a time parameter; (g) a physical location parameter; (h) a parameter varying according to an active interaction with a consumer; (i) a parameter varying according to a passive interaction with a consumer; (j) a targeted content parameter; (k) a brand parameter; and (l) a point of sale parameter.

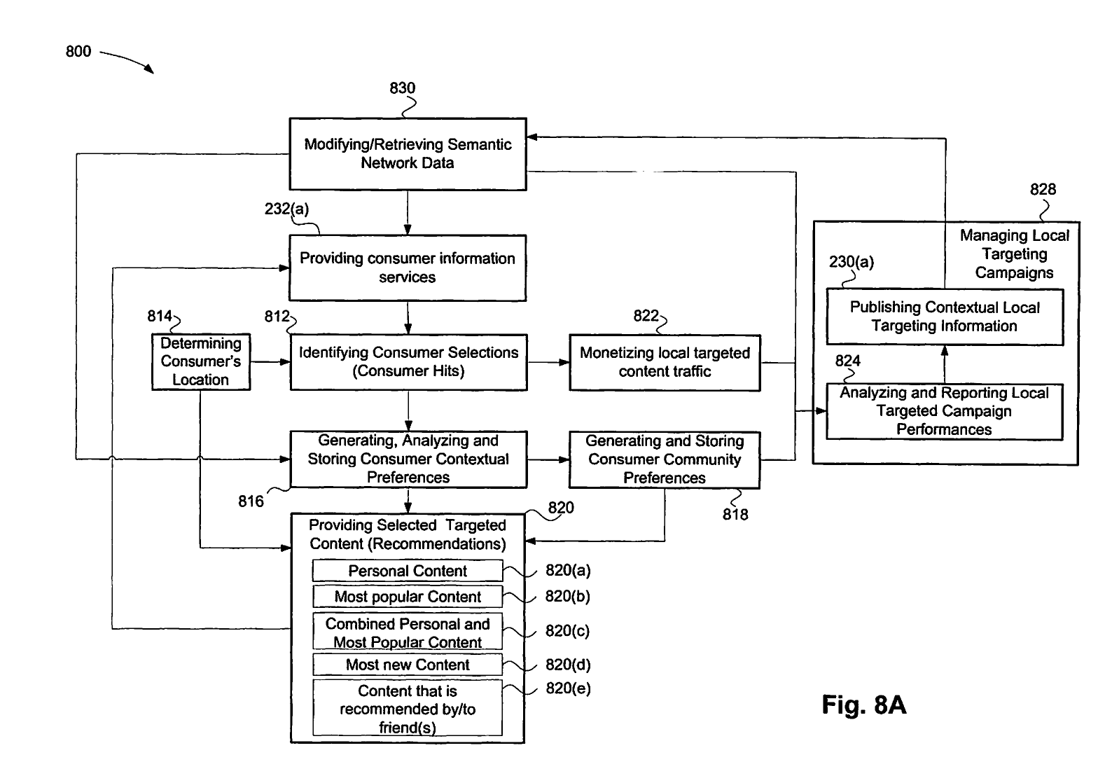

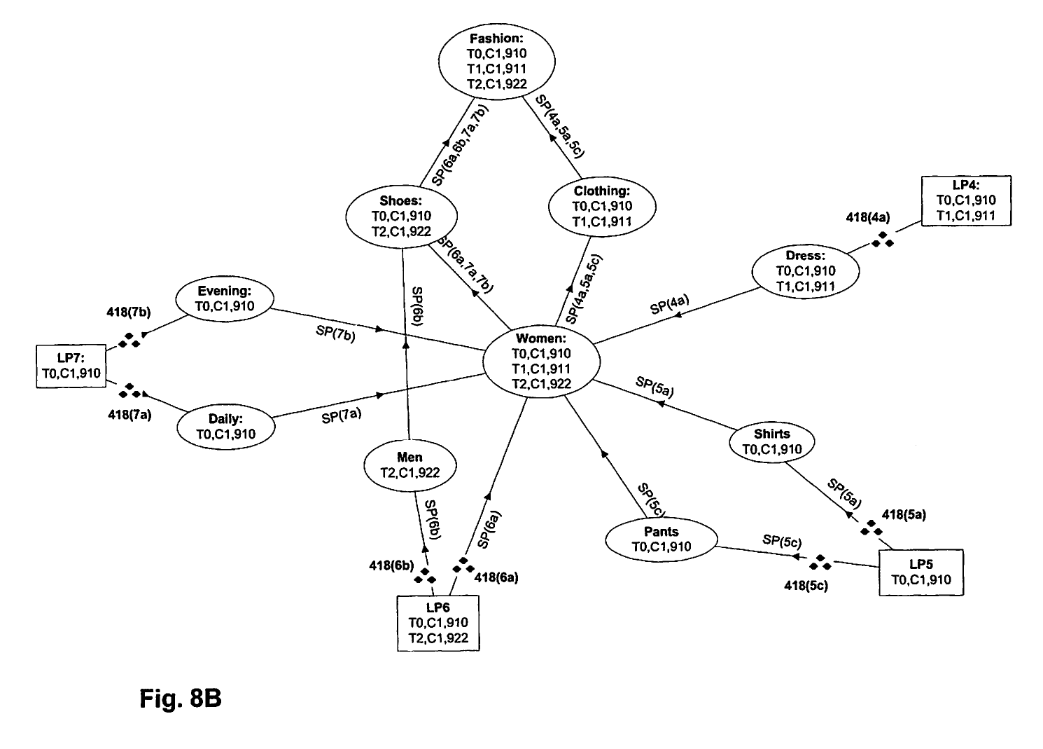

FIG. 8A is a schematic flow-chart 800 of the reciprocal data transfer between consumers' and advertisers' devices, according to an embodiment of the present invention. According to an embodiment of the present invention, system 100 (FIG. 1) is capable to provide selected targeted content (recommendations) to a plurality of local market consumers 110 (FIG. 1). The above selected targeted content can be displayed on consumers' mobile devices 120 (FIG. 1) according to a plurality of factors (such as specific consumers' preferences, other consumers' preferences, consumers' locations, local market environmental factors (e.g., marketing and spatial factors), time, etc.) and/or a plurality of metricses (e.g., statistical metricses). In turn, local market reports can be provided to a plurality of advertisers, which may enable them to determine the cost effectiveness (rank/score) of their local targeted advertizing/marketing campaigns.

According to an embodiment of the present invention, an anonymous contextual consumer preferences analysis can be performed according to a selection(s) of each consumer, thereby eliminating the need in determining and possibly revealing consumer's personal information (such as consumer's name, age, address, and the like). For this, each consumer at the time of entering the predefined shopping site can be assigned with a unique identification (ID) number. Then, each action performed by the consumer will be associated with the above-assigned ID number, thus enabling the consumer to remain anonymous. After that, when the consumer leaves the shopping site, this ID number along with all activity history can be deleted from system 100. As a result, the outcomes of said contextual consumer preferences analysis can be used for conducting a consumer community preferences analysis. Thus, system 100 does not need to acquire and use any consumer' personal data (e.g., consumers' personal details, such as demographic details, socioeconomic details, bank account details, credit account details, consumers friends' personal details, etc.) to determine said consumer's preferences. Since consumer selections represent consumers' shopping behavior, system 100 can identify consumer's preferences by analyzing the consumer selections, which in turn can significantly increase relevancy of the target content to be presented to said consumer on his mobile device. It should be also noted that consumer's preferences history can be also updated/erased periodically (e.g., at the end of the shopping day). As a result, system 100 can provide significantly relevant data to a plurality of consumers in a private manner, enabling them to stay anonymous. As a result, the consumer satisfaction may be significantly increased, and thereby the cost effectiveness may be correspondingly improved. Further, various metrics can be calculated with regard to the behavior of each anonymous consumer and/or a group of anonymous consumers within the predefined shopping site, thereby enabling to provide for example additional information (e.g., reports) to advertisers regarding the cost-effectiveness of their targeted advertising campaigns with regard to anonymous consumers. Similarly, such the above reports can be generated with regard to any consumer and/or a group of consumers of the predefined shopping site. In addition, it should be noted that reports can be generated and provided to advertisers substantially in real-time, thereby in turn enabling them to make the substantially real-time action with regard to their products/services: for example, enabling them to inform substantially in real-time a plurality of consumers regarding a special discount for the above products and services.

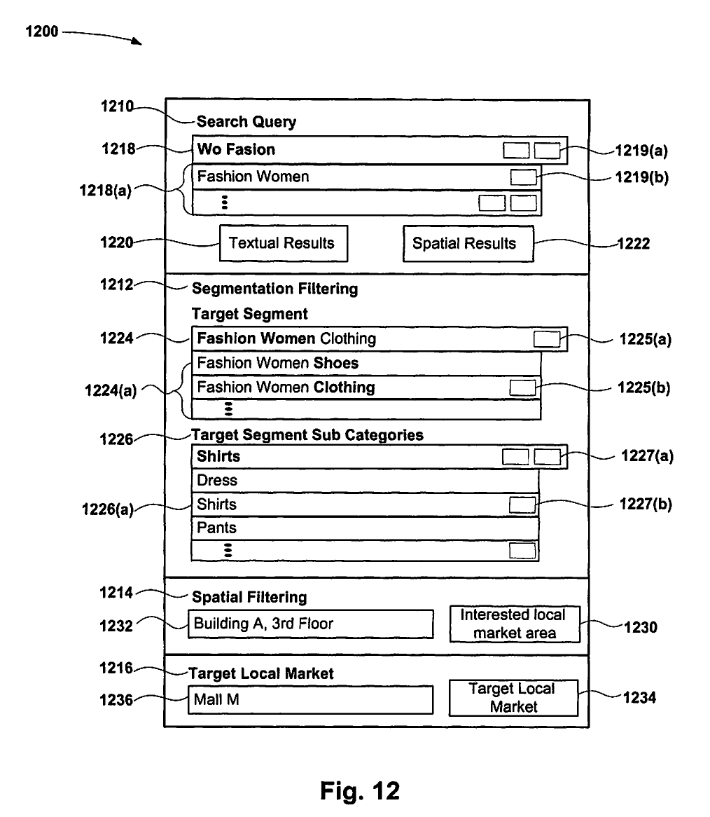

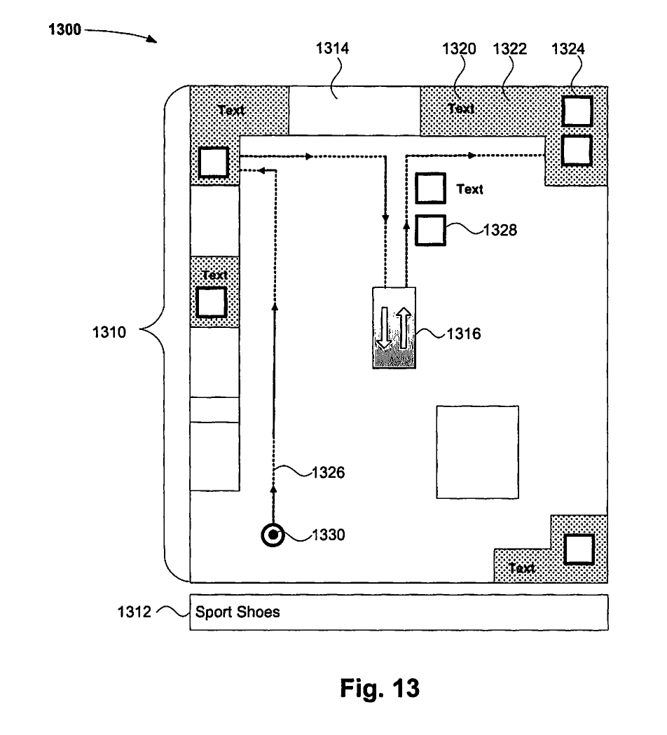

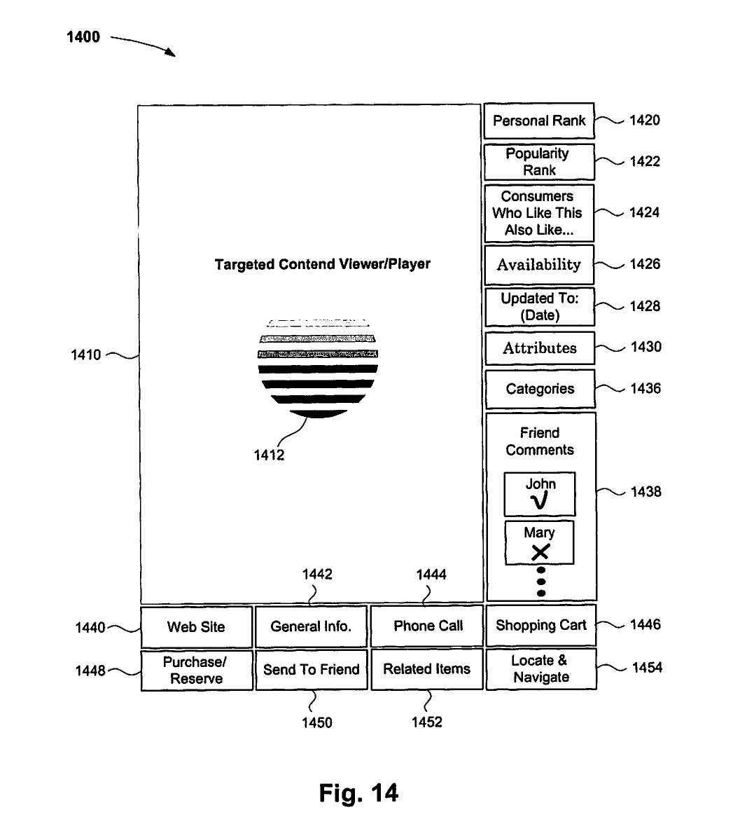

According to an embodiment of the present invention, at step 232(a), a consumer connects to system 100 by means of his mobile device 120, and performs desired operations (makes desired selections). In turn, the corresponding personal and relevant information may be presented, substantially in real-time, to said consumer (in order to assist him in his shopping journey) by means of one or more interfaces such as contextual local search query interface 1200 (FIG. 12); contextual shopping map interface 1300 (FIG. 13); target content exposure interface 1400 (FIG. 14).

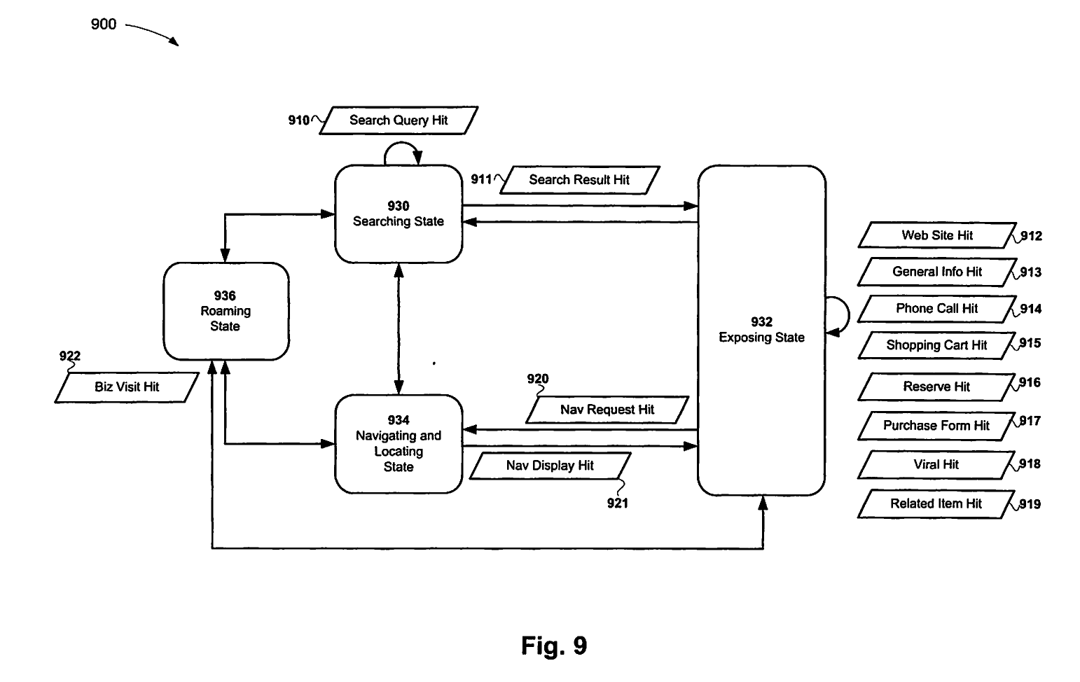

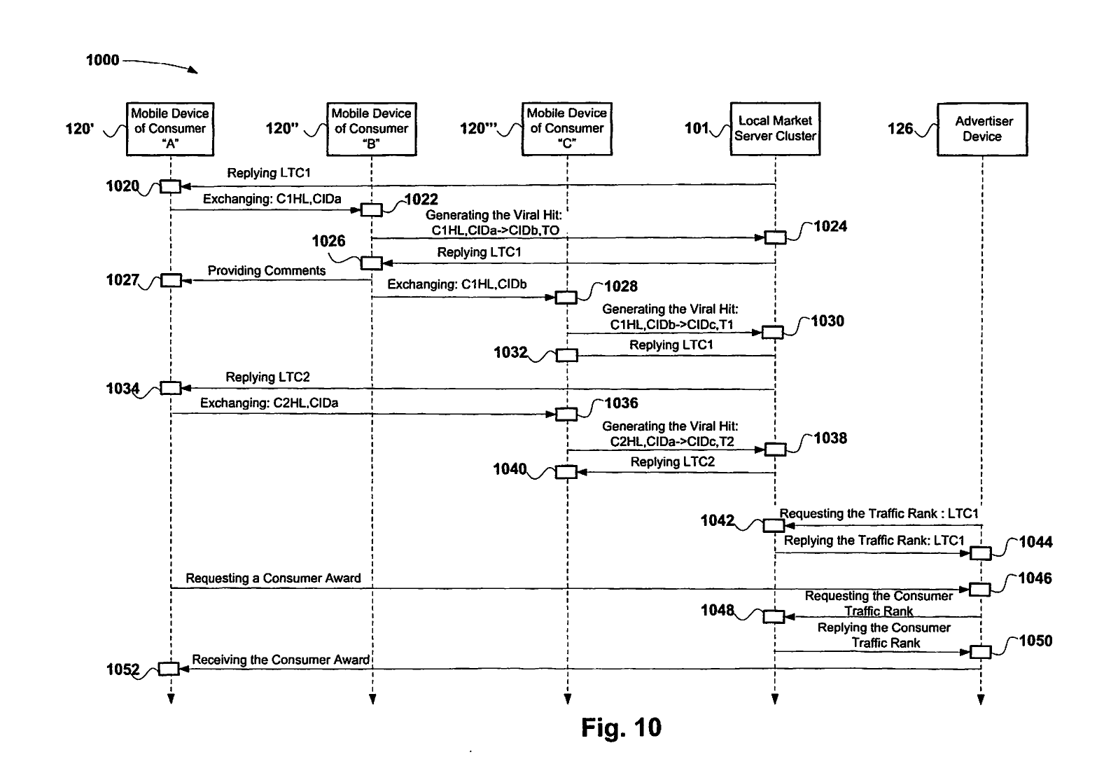

At step 812, consumer selections are identified by system 100. In addition, a particular consumer location, which can be identified at step 814, can be assigned to a corresponding consumer selection (e.g., a consumer that visits a particular shop within a predefined physical site indirectly selects categories, which are related to this shop). According to an embodiment of the present invention, consumer selections can be classified into various types of hits (giving rise to “consumer hits”, as presented in FIG. 9) such as: a Search Query Hit 910, which is generated after a search query is submitted by using contextual local search query interface 1200, at step 232(a) for example; a Search Result Hit 911 (FIG. 9), which is generated after the consumer selects a search result item by using a contextual local search query interface; a Site Hit 912 (FIG. 9), which is generated after the consumer surfs to advertiser's Web site by pressing a Web site hyperlink; a General Info Hit 913 (FIG. 9), which is generated after the consumer reviews information of a specific local advertiser (provider); a Phone Call Hit 914 (FIG. 9), which is generated after the consumer make a phone call to local advertiser (provider) by pressing a corresponding hyperlink; a Shopping Cart Hit 915 (FIG. 9) that is generated after the consumer selects a local target content, listed within a virtual shopping cart; a Reserve Hit 916 (FIG. 9) that is generated after the consumer submits product/service reservation form, which is associated to the particular target content; a Purchase Form Hit 917 (FIG. 9) that is generated after the consumer submits a product/service purchase form, which is associated to the particular target content; a Viral Hit 918 (FIG. 9, FIG. 10) that is generated after the consumer send an instance message (related to a specific local targeted content) to a friend; a Related Targeted Content Hit 919 (FIG. 9) that is generated after the consumer passes from one targeted content object to other targeted content object, which is related to one of item presented to the consumer; a Nav Request Hit 920 (FIG. 9) that is generated after the consumer activates navigation request for attending either a particular target content location or a particular local business location, provided to the consumer; a Nav Display Hit 921 (FIG. 9) that is generated after the consumer activates a contextual target hyperlink by using contextual shopping map services; Biz Visit Hit 922 (FIG. 9) that is generated upon determining that a consumer stays inside a specific local shop, according to a predefined criteria (e.g., more than 5 minutes). This can be determined, for example, by receiving the consumer's location by using the locator unit 142, and by determining corresponding “consumer hits”.

It should be noted that, according to an embodiment of the present invention, the term “contextual preferences” refers to contextual relations between a consumer hit and the preference of the particular consumer (e.g., a consumer who is searching, for example, by means of contextual local search query interface 1200 for the term “women fashion” most probably is interested in various women fashion categories and less in categories related other fields, such as “electronics”.

According to an embodiment of the present invention, at step 816, consumer contextual preferences data objects are first generated by means of Consumer Contextual Preferences unit 152 (FIG. 1). These preferences derived from a plurality of factors such as (a) consumer hit/selection factors (such as the weight of each consumer hit), determined at step 812; (b) results of analyzing semantic network 400 (FIG. 5) objects, which are contextually related to said consumer hits by segmentation paths 440 (FIG. 4); (c) local market time tags, which are generated by the local scheduler unit 158 (FIG. 1); (d) consumer IDs; etc. Then, the contextual consumer preferences objects are stored within the Consumers' Preferences Database 162 (FIG. 1).

For example, a particular consumer denoted as “C1” submits the search query “Women Fashion” (FIG. 5) at a particular local market time “T0”. As a result, the consumer is provided with search results, which are related to the following segmentation paths 440 (FIG. 4): “SP(4a)”, “SP(5a)”, “SP(5c)”, “SP(6a)”, “SP(7a)”, and “SP(7b)” (FIG. 5). In turn, a Search Query Hit 910 (FIG. 9) is generated and leads to the generation of the following contextual consumer's preferences objects “Pref1” to “Pref6” (as further presented in FIG. 8B, which is a schematic illustration of contextual preferences objects related to an individual consumer, according to an embodiment of the present invention):

### Pref1={“T0”, “C1”, “910”, “Fashion”, “Clothing”, “Women”, “Dress”, . . . , “LP4”}.

### Pref2={“T0”, “C1”, “910”, “Fashion”, “Clothing”, “Women”, “Shirts”, . . . , “LP5”}.

### Pref3={“T0”, “C1”, “910”, “Fashion”, “Clothing”, “Women”, “Pants”, . . . , “LP5”}.

### Pref4={“T0”, “C1”, “910”, “Fashion”, “Shoes”, “Women”, . . . , “LP6”}.

### Pref5={“T0”, “C1”, “910”, “Fashion”, “Shoes”, “Women”, “Daily”, . . . , “LP7”}.

### Pref6={“T0”, “C1”, “910”, “Fashion”, “Shoes”, “Women”, “Evening”, . . . , “LP7”}.

In addition, system 100 exposes to the consumer the following list of local targeted content references {418(4a), 418(5a), 418(5c), 418(6a), 418(7a), 418(7b)} which are related to the above segmentation paths “SP(4a)”, “SP(5a)”, “SP(5c)”, “SP(6a)”, “SP(7a)”, and “SP(7b)”, respectively (FIGS. 5 and 8B). Then, at the local time “T1”, it is supposed that the consumer (“C1”) selects a product “Prod4a”, which is related to segmentation path “SP(4a)”. As a result, Search Result Hit 911 (FIG. 9) is generated, leading to the following contextual consumer's preferences object “Pref7”: Pref7={“T1,”“C1”, “911”, “Fashion”, “Clothing”, “Women”, “Dress”, . . . , “LP4”}. After that, at the local time “T2”, the consumer (“C1”) decides to visit a specific local shop, which is identified by “LB6” (FIG. 5). This consumer selection raises a “Local Biz Visit Hit” 922 (FIG. 9) and, in turn, the following contextual consumer's preferences object are generated:

### Pref8={“T2”, “C1”, “922”, “Fashion”, “Shoes”, “Women”, . . . , “LP6”

### Pref9={“T2”, “C1”, “922”, “Fashion”, “Shoes”, “Men”, . . . , “LP6”.

According to an embodiment of the present invention, at step 818, the consumer contextual preferences are transformed to consumer community preferences to be stored within the Consumers' Preferences database 162 (FIG. 1). This transformation is based on the individual consumer preferences analysis, according to the particular consumer contextual preferences data (that is also stored within Consumers' Preferences database 162). It should be noted that the individual consumer contextual preferences, as well as the consumer community preferences, are dynamic and can be changed, for example, during the consumer's shopping journey or during different shopping seasons. Also, it should be noted that the individual consumer contextual preferences, as well as the consumer community preferences, may be related to selections of an anonymous consumer.

According to an embodiment of the present invention, at step 820, system 100 provides selected targeted content to a plurality of consumers, based on relevancy ranks provided by means of Contextual Recommendation unit 153 (FIG. 1). In turn, the ranks are continually updated based on the dynamic analysis of plural factors such as: individual consumer preferences; consumer community preferences; the local market physical structure; the local marketing structure; local market inventory availability; consumer's location; time; etc.

According to an embodiment of the present invention, the selected targeted content to be provided to each consumer can be divided, based on semantic network 400 (FIG. 4) and consumer's preferences, to the following types, for example: (a) “personal selected targeted content” 820(a), which is based on the analysis of individual consumer contextual preferences (e.g., relevant shops/products/services information, which relate to categories and local market segments being preferred by a consumer); (b) “most popular selected targeted content” 820(b), which is based on the analysis of consumer community preferences (e.g., the most interesting category/product/service/shop within a predefined physical site (the local market)); (c) “combined personal and most popular content” 820(c), which is based on the analysis of consumer preferences and the consumer community preferences, according to the predefined criteria (a set of rules). For example, a consumer who is interested in a particular fashion brand (e.g., the “X fashion” brand), is also interested in another fashion brand (e.g., the “Y fashion” brand); (d) “most new selected targeted content” 820(d), which are based on how the local market information, represented by targeted content objects 418 (FIG. 4), is up to date; (e) “friend-based selected targeted content” 820(e), which based on targeted content objects 418 that are exchanged with friends. For example, it is supposed that a particular consumer exchanges sport shoes advertisement with his friend. The consumer's friend likes the sport shoes presented in the advertisement received from the consumer, and he replies positively to said consumer. As a result, a recommendation mark is presented to the consumer by means of the shopping map interface (FIG. 12). Thus, for example, personal selected targeted content can be related to both “women clothes” and “women shoes” local market segments, based on the relevancy ranks, which may be provided by Contextual Consumer Recommendation unit 152. Thus, according to an embodiment of the present invention, the consumer's selected targeted content does not depend on the explicit selection(s) of the consumer (i.e., system 100 is capable to provide selected targeted content to consumers (such as relevant category or segment) even if the consumers are not explicitly aware of this content. These selected targeted content may assist consumers to determine relevant information, substantially in real-time. The selected targeted content can be provided, for example, to consumers by: (a) contextual search query interface 1200 (FIG. 12), enabling to present textual and graphic selected targeted content, thereby assisting the consumer to select relevant data and to refine the search query; (b) contextual local map interface 1300 (FIG. 13), enabling to present, for example, recommended shops and recommended local market areas, which relate to recommended objects (such as preferred categories and market segments) by providing corresponding marks/highlighting on the map; (c) targeted content exposure interface 1400 (FIG. 14), enabling to present to consumes the recommended product/service/business marks, such as “best choice marks”.

According to an embodiment of the present invention, at step 822, the advertisers' accounts are charged (for using system 100 services) based a monetization method, which is performed by targeted campaign monetization unit 164 (FIG. 1) and which is based on measuring the contextual information traffic with respect to each advertiser's account. It should be noted that the contextual information traffic measurements can be separated to one or more objects comprising: category objects (420,422); targeted content objects 418; advertiser objects (426, 430) as well as any spatial structure 300(a) object types. Thus, the advertisers can assess the cost-effectiveness of their targeted campaigns in a relatively accurate manner (for example, each advertiser can assess the cost-effectiveness of a particular advertisement, particular category, or particular point of sale with regard to a particular targeted campaign).

According to an embodiment of the present invention, at step 824, the advertiser conducts a targeted campaign analysis and, in turn, system 100 provides a plurality of reports to assist the advertiser to assess and control the targeted campaign (as also shown in FIG. 15). The targeted campaign analysis is based on inputs provided data by executing steps 818, 822, and 830.

Since the targeted campaign reports may affect targeted campaigns, the advertisers 111 (FIG. 1) upon receiving such reports may change/focus their local targeted advertizing and marketing efforts according to foundings presented in these reports. As a result, the targeted advertizing/marketing strategy of the advertiser may be continuously updated. Further, according to an embodiment of the present invention, at step 230(a), the advertiser distributes local targeted content (LTC) to the target local market (e.g., a particular shopping mall), which in turn affects the semantic network (400) data at step 830. According to this embodiment of the present invention, at step 828 advertisers might manage targeted campaigns at target local markets by publishing contextual local targeted information (at step 230(a)) as well as by assessing and reporting campaign performances (at step 824).

FIG. 9 is a state-machine block-diagram 900, which represents possible states of system 100 (FIG. 1) with regard to particular consumer activities, which are determined and managed by said system 100, according to an embodiment of the present invention. It should be noted that, according this embodiment, system 100 manages different state machine for each consumer mobile device 120 (FIG. 1). The states and transits of system 100 are determined by analyzing each consumer operation modes as well as analyzing movement of the consumer within a predefined physical site.

According to an embodiment of the present invention, system 100 enters into “Searching state” 930, according to contextual local search operations conducted by a consumer by using contextual search query interface 1200 (FIG. 12) as well as contextual search query result interface (not shown). While staying in “Searching state” 930, the consumer can select, for example, one of the following options for obtaining relevant information: (a) the consumer may conduct a search for a particular search term. As a result, a search query hit 910 is generated and the state remains to be the “Searching state” 930; (b) the consumer may select a search result item, which will lead to obtaining a search result hit 911 and, in turn, the system state will be changed to “Exposing state” 932; (c) the consumer may load a local market map, provided by Contextual Shopping Map unit 143 (FIG. 1). This operation will lead to changing the system state to the “navigating and locating state” 934. It should be noted that the “Searching state” 930 can be activated by specific consumer services operations, while staying in either “Exposing state” 932 or “Navigating state” 934.

According to this embodiment of the present invention, system enters “Exposing state” 932 according to the target content exposure by using targeted content exposure interface 1400 (FIG. 14). The “Exposing state” 932 can be activated by specific consumer services operations, while staying in either “Searching state” 930 or “navigating state” 934. After the “Exposing state” is activated, the local target content is presented on consumer's mobile device 120 (FIG. 1). The initial local target content presented in this state relates to either search result item or local market contextual local map item, which was selected by the consumer in previous states. Also, while staying in “exposing state” 932, the consumer is exposed to the local targeted content (LTC) provided by the advertiser. The consumer might conduct further activities that initiate corresponding consumer hits, such as Site Hit 912, General Info Hit 913, Phone Call Hit 914, Shopping Cart Hit 915, Reserve Hit 916, Purchase Form Hit 917, Viral Hit 918. In addition, further information browsing/exploring activities performed by the consumer might cause the system to change local target content and, in turn, initiate ‘Related Targeted Content Hit’ 919. Moreover, the consumer may want to locate and/or navigate to the LTC object or to a point of sale (local advertiser), thereby raising Nav (Navigating) Request Hit 920. In this case, the state is changed to Navigating and Locating State 934.

According to this embodiment of the present invention, system 100 enters into “Navigating and Locating State” 934 according to a location-based services (LBS) operation performed by consumers by using contextual shopping map interface 1300 (FIG. 13). According to this embodiment of the present invention, “Navigating and Locating State” 934 can be activated by specific consumer services operations, while staying in either “Searching state” 930 or “Exposing state” 932. According to this embodiment of the present invention, while staying in “Navigating and Locating State” 932, the consumer can expose the content of relevant object presented by the contextual shopping map. In this case, the system state is changed to “Exposing state” 932 and a Nav Display Hit 920 is generated. In addition, the consumer can conduct a search request, which cause, the state to be changed to “Exposing state” 932.

According to an embodiment of the present invention, the “Roaming State” 936 can be activated automatically if one or more of the following events/activities, related to a specific consumer, occur: (a) Locator unit 142 (FIG. 1) identifies a relocation (movement) of the consumer, according to the current location of consumer's mobile device 120; (b) the consumer mobile apparatus is in an idle mode; (c) the elapsed time duration with regard to the consumer's last session is shorter than a predefined threshold period of time. If all of the above events/activities occur, then system 100 execute the following operations: (a) the current consumer session state is changed to “Roaming State” 936; (b) the consumer current location is updated, according to the location provided by means of the locator unit 142; (c) Biz Visit Hit 922 is generated; and (d) the initial consumer session state is preserved for further usage.

According to an embodiment of the present invention, system 100 is capable to enable consumers to exchange information as well as to enable advertisers to increase targeted content awareness through self-replicating viral processes which are denoted as “viral marketing” and “viral advertising”. System 100 is capable to support said viral processes by: (a) enabling data sharing among consumer mobile devices 120 by means of generating hyperlinks to target content as well as to target context. These hyperlinks can be exchanged between said mobile devices 120 (FIG. 1) based on conventional techniques, such as email, SMS/MMS, and the like; (b) measuring targeted content exchanges between targeted consumers; and (c) awarding targeted consumers based on the volume of these exchanges (e.g., based on the shared/exchanged data, sent email or SMS/MMS messages). The consumer awarding can be, for example, providing the consumer with a discount, a coupon, a voucher, a gift, and the like; also, the awarding can be provided by the corresponding advertiser. It should be noted that consumers may be required to register for the awarding services in order to receive the awarding (in case it will be granted). Also, it should be noted, that advertisers can generate a report of all consumer registered to the awarding services in order to determine the consumer(s), to which said awarding should be granted.

FIG. 10 is a sample sequence (interaction) diagram 1000 for enabling and measuring both targeted content and context exchange, according to an embodiment of the present invention. Diagram 1000 depicts, for example, the following elements: tree consumer's mobile devisees 120′, 120″, and 120′″, one local market server cluster (LMSC) 101, and one advertiser device 126, which operate simultaneously all together. In addition, diagram 1000 depicts targeted content messages, which are exchanged (in an order in which they occur) between the above elements over data network 148 (FIG. 1).

According to an embodiment of the present invention, the data communication between said each consumer mobile device 120′, 120″, and 120′″ and the local market server cluster (LMSC) 101 is performed through the remote consumer services apparatus 127 (FIG. 1). Similarly, the data communication between advertiser's device 126 and LMSC 101 is performed through remote advertiser services apparatus 128 (FIG. 1).

It should be noted that, according to an embodiment of the present invention, the communication between the consumers' mobile devices can be based on conventional data communication messaging techniques, such as email, SMS/MMS or any other techniques, which enable consumers to exchange hyperlinks of target content data provided by system 100 over data network 148 by using direct data messaging between consumer mobile devices.

According to this embodiment of the present invention, at step 1020, a local targeted content “LTC1” is provided to mobile device 120′ of “Consumer A” by LMSC 101. At step 1022, the “Consumer A” transmits a data message (e.g., email, SMS/MMS) to “Consumer B” which contains a hyperlink to the targeted content (denoted as “C1HL”) and the anonymous consumer identification (CID) of the message sender (denoted by “CIDa”). At step 1024, the message addressee, “Consumer B”, activates the “CIHL” hyperlink (the “targeted content reference”). As a result, the LMSC 101 performs the following activities: (a) generates “Viral Hit” 918 (FIG. 9); (b) preserves the consumer's hit data: {sender identification (e.g., “CIDa”); addressee identification (e.g., “CIDb”), the hit occurrence time/date (e.g., “T1”, “T2”, and the like), etc.}; and (c) providing the requested “LTC1” data to “Consumer B” device 120″ at step 1026. It should be noted that “Consumer B” can provide a positive/negative comment to the “Consumer A” regarding the exchanged targeted content “LTC1” (at step 1027). Similarly, the “Consumer B” can exchange the targeted content data “C1HL” with the “Consumer C” (identified as “CIDc”) at steps 1028, 1030, and 1032 at the particular local market time “T1”. In addition, the “Consumer A” can also send the targeted content hyperlink “C2HL” to the mobile device 120′″ of “Consumer C”, according to steps 1034, 1036, 1038, and 1040.

According to an embodiment of the present invention, at steps 1042 and 1044, system 100 provides a plurality of traffic ranks (such as the viral traffic ranks) and related market response (metrics) reports based on the analysis of the consumer traffic, which is derived from the consumer's selections (e.g., hits) with regard to a plurality semantic network objects 500 (FIG. 5), such as network object “LTC1”. It should be noted that for example, the viral traffic ranks can be derived from the following measurements, comprising: viral hit occurrences and viral hits depth, i.e a number of exchanges of a single target content reference among two or more consumers. Further, at steps 1046, 1048, 1050, 1052, the advertiser can take an advantage of the consumer's traffic metrics (and in turn, of the consumer's traffic ranking, performed by system 100), in order to award particular consumers and provide them, for example, discounts, coupons, and the like.

It should be noted that according to an embodiment of the present invention, any data (objects) of system 100 can be exchanged among consumers by using other methods, which are similar to the method presented in FIG. 10. The above data (objects) may comprise: (a) segmentation paths data; (b) advertiser general information and related attributes data; (c) spatial object data; (d) walking paths; (e) shopping map information; (f) search query and/or search results; (g) recommendations (e.g., selected targeted content); (h) virtual shopping cart data; and the like. Similarly, according to another embodiment of the present invention, any data (objects) of system 100 can be exchanged between a particular advertiser and a particular consumer, who is registered to the data exchange services provided by said advertiser.

Further, it should be noted that according to still another embodiment of the present invention, both C2C (Consumer To Consumer) and B2C (Business To Consumer) data exchange can be supported by conventional data security techniques/methods. Thus, a relatively sufficient degree of data security and anonymity can be guaranteed for providing said data exchange. FIG. 11 is a sample flow chart 1100 of a contextual local market search method, according to an embodiment of the present invention. According to this embodiment, the maximum (optimal) match between the desired relevant information and anonymous consumer request is to be determined by using local market semantic networks 400 (FIG. 4).

At step 1112, the contextual search inputs are provided by the consumer, enabling determining a scope of the requested information. According to an embodiment of the present invention, the contextual search input types are, for example, as follows: (a) search keywords, which represent textual search queries (the search keywords are provided by using mobile device 120 (FIG. 1)); (b) a particular local market area that interests the consumer; (c) a consumer's location, which may represent the actual location of the consumer within the local market. These inputs can be provided, for example, manually by using contextual search query interface 1200 (FIG. 12) displayed on consumer's mobile apparatus 120 (FIG. 1). In addition, the above inputs can be provided automatically by system 100 (FIG. 1), according to previous operations/searches of the consumer as well as according to consumer's preferences that can be retrieved from the Contextual Consumer's Preferences unit 152.

At step 1114, the automatic correction and completion of a consumer's search query can be performed, according to a contextual dictionary of predefined terms, which can be stored, for example, within Semantic Database 160 (FIG. 1). According to an embodiment of the present invention, the contextual correction and completion can be performed by using contextual term matching, which may involve not only term (query) text matching but also term context matching. According to an embodiment of the present invention, the contextual term matching can logically depend on semantic network 400 objects and contextual links. The contextual term matching can be defined by the following criterions: (a) the searched queries are considered to be “close to” predefined terms (words) stored in semantic network 400 by executing a word similarity analysis; and (b) there is at least one segmentation path, such as a segmentation path object 440′ (FIG. 6B), that is associated to semantic network 400 objects, which is related to said predefined terms. As a result, the consumer may obtain more relevant information in a faster way. For example, according to the semantic network illustrated in FIG. 5, if the consumer search query is “ev sh”, then according to the above first criterion (a), from semantic network 400 are selected terms which are “close to” the term “ev” (such as the term (“evening”)), and similarly are selected terms which are “close to” the term “sh” (such as the terms (“shoes”, “shirts”)). According the above second criterion (b), there is only one segmentation path “SP(7b)” (FIG. 5), which is associated with the above both terms (“evening”) and (“shoes”, “shirts”). Therefore, the suggested corrected/completed term would be “evening shoes”. It should be noted that, according to this embodiment of the present invention, the above words similarity analysis can be defined by the following function: WordDistance (w1,w2), wherein w1 and w2 are two terms, and the output of the function is the logical distance between said two terms. This function can be implemented, for example, by using a conventional prior art “Levenshtein Distance” algorithm, which calculates the minimum number of operations required to transform one string into another, wherein each operation can be an insertion, deletion, or substitution of a single word character (e.g., a letter). For example, if w1=“shous” and w2=“shos”, then WordDistance (“shous”, “shos”)=1, and if w1=“shous” and w2=“sport”, then WordDistance (“shous”,“sport”)=3.

At step 1116, the contextual search query is validated. It should be noted that the contextual search query may be considered as invalid with regard to a unique scope of a particular market semantic network 400. Invalid search query can be defined, for example, as a query which is not related to any sets of semantic network 400 objects associated by a single segmentation path, such as a segmentation path object 440′ (FIG. 6B). For example, it can be supposed that a consumer is looking for “teenagers sport shirts”, according to the sample local market network of FIG. 5. Since in FIG. 5 there is no local advertiser 426 (FIG. 4), which sells teenagers sport shirts, thus there is no single segmentation path, which is associated with the terms: “teenagers”, “sport”, and “shirts”. As a result, system 100 can determine other valid terms (such as “teenagers sport”), and then suggest these valid terms to the consumer.

In step 1118, the spatial filtering may be performed for reducing a search query scope based on the local market area being of a particular interest to the consumer. As a result, the consumer may obtain relevant information in a faster manner, since less irrelevant information will be provided to him. According to an embodiment of the present invention, the spatial filtering is based on the market regions of interest, representing local market regions (such as the “3^{rd} floor”), which can be of a particular interest to the consumer. According to an embodiment of the present invention, the market regions of interest can be, for example: building floors 318 (FIG. 3); open spaces 314 (FIG. 3); and local advertiser interiors areas (nested cells layers) 330 (FIG. 3), which can be determined y means of contextual shopping map interface (FIG. 13). For example, if a consumer defines a market region of interest by using his mobile device 120 (FIG. 1) as the “2^{nd} floor of Building A” and conducts a search by using a search query “coffee”, then the search results presented to the consumer may be all coffee shops, which are located on the “2^{nd} floor of Building A”.

Further, at step 1120, the segmentation path filtering may be applied to the consumer's search query. According to an embodiment if the present invention, the segmentation path filtering can be obtained by identifying matching between the consumer's search query and terms that are related to specific segmentation paths. It should be noted that, according to an embodiment of the present invention, a search query textual term (e.g., a keyword) may match at least one term associated with one of the semantic network objects, such as targeted content object 418 (FIG. 4), category object 420 (FIG. 4), common category object 422 (FIG. 4), local advertiser object 426, local market operator objects 428, brand object 430, etc. Thus, each search query may be associated with at least one segmentation path. Thus, according to an embodiment if the present invention, only segmentation paths that are related to the search query terms, according to said textual term matching, will be determined. As a result, the consumer may obtain relevant information in a faster manner, since less irrelevant information may be provided. For example, if the consumer uses the following search query set (“fashion”, “women”), according to the local market network of FIG. 5, then the following six segmentation paths being related to these both keywords will be determined: SP(4a), SP(5a), SP(5c), SP(6a), SP(7a), and SP(7b). It should be noted that according to FIG. 5, there are total ten segmentation paths (SP(4a), SP(5b), SP(5c) SP(5d), SP(12a), SP(6a), SP(6b),SP(7a), SP(7b)), which are related either to the term “fashion” or to the term “women”. Therefore, it should be noted that according to this example, the segmentation path filtering reduces the search result scope by 40% (four segmentation parts out of term are eliminated).

Also, it should be noted that, according to an embodiment of the present invention, a “search query hit” 910 (FIG. 9) is generated for obtaining search results in each of the following steps: 1112, 1114, 1116, 1118, 1120.

At step 1122, various target content metrics can be calculated/determined (such as segmentation path rank metrics, personal consumer preferences rank metrics, consumer community preference rank metrics, target distance metrics, etc.) for enabling assisting consumers in obtaining relevant content in a relatively short period of time and enabling to provide to the consumer personal recommendations with regard to these metrics (e.g., statistical metrics). Also, the above metrics can be analyzed by a plurality of advertisers in order to determine the corresponding market response metrics for improving, for example, the cost-effectiveness of their advertising campaigns. As mentioned above, the target content metrics may comprise: (a) segmentation path rank metrics, indicating the content that maximally (optimally) matches the consumer search query; (b) personal consumer preferences rank metrics, defining a level of personal consumer preferences with regard to the particular semantic network (such as network 400); it should be noted that the personal consumer preferences rank is dynamic and can be significantly changed during the shopping journey; (c) consumer community preferences rank metrics, defining a level of consumer community preferences with regard the particular semantic network (such as network 400). It should be noted that the consumer community preferences rank may be changed periodically, each predefined period of time, such as every day, week, month, season, etc.; (d) target distance metrics, representing the physical distance (e.g., in meters) between the current physical location of the consumer and the location of the corresponding targeted content object (product/service) or the location of related local advertiser that provide this object, wherein the target distance can be derived, for example, by determining local market walking paths at step 222 (FIG. 2); as a result, the consumer can select the most relevant target content items from a search result list, according to his search query. Also, it should be noted that a result of each performed metrics can be further analyzed for determining a plurality of factors that influenced on said result such as: (a) the location of the predefined physical site; (b) the location the point-of-sale (POS) within said predefined physical site; (c) the location of a particular region of each point-of-sale; (d) the spatial structure of said predefined physical site; (e) at least one targeted content item being sold within the predefined physical site; (f) a category of said targeted content item; and (g) the calendar time interval, to which the metrics is related. In addition, the metrics of several predefined physical sites (several local markets) can be compared by determining the geographic location of each of said at least two predefined physical sites and analyzing the marketing environment of each of said two predefined physical sites with regard to said geographic location. Then, the results of this comparison can provide advertisers with important information as how to improve their advertising campaigns.

It should be noted that according to an embodiment of the present invention, the segmentation path rank defines the matching level between a target segmentation path, which represents a certain target content, and a given search keyword, which is provided by the consumer. Thus, the segmentation path rank indicates the content that maximally matches the consumer search query. The segmentation path rank may depend on a variety of parameters, such as target segmentation paths, search keywords parameters (e.g., a search keyword rate that may represent a percentage of matching of a specific consumer's search query to a corresponding product/service category), weight of each semantic network object type, category order with regard to particular segmentation path 440 (FIG. 4), and the like. Also, the personal consumer preferences rank as well as the consumer community preferences rank, which can be both calculated and used in step 1122, define a level of consumer preference with regard to category object chains, targeted contents, advertiser and local providers, etc.

According to an embodiment of the present invention, at step 1124, consumer's selected targeted content with regard to step 820 (FIG. 8A) may be provided with one or more search result items, according to the matching ranks. For example, it is supposed that a consumer conducts a search for the “sport shoes”. In turn, he receive a search result list along a recommendation mark located near an item (within said list), which is related to the “teenagers sport shoes” (according to the consumer's preference with regard to the “teenager” category). Thus, the matching rank between the search result item and the local market category (e.g., the “teenager” category), can be determined based on the semantic network 400 (FIG. 4) data and based on the consumer's preferences data.

At step 1126, the contextual search results combined with selected targeted content (recommendation) are displayed on consumer's mobile device 120. Upon receiving the search results, the consumer can refine his search query. After that, at step 1128, upon selecting the desired content item (e.g., a product, service, point of sale, etc.), a Search Result Hit 911 (FIG. 9) is generated. The consumer can select the desired content by: a corresponding search result list interface (not shown), such as contextual target list interface displaying a plurality of targeted content item hyperlinks; a contextual local map interface 1300 (FIG. 13), displaying a map of target local advertiser within the local market area; and the like. Also, it should be noted that according to an embodiment of the present invention, the consumer can refine the search query at each step of method 1100, thereby returning to step 1112.

FIG. 12 schematically illustrates a contextual search query interface 1200, according to an embodiment of the present invention. According to this embodiment, contextual search query interface 1200 can be used for: enabling consumer to conduct a search with regard to semantic network 400 (FIG. 4); assisting consumer in refining search queries; and enabling acquiring data that indicate consumers' selections.

According to an embodiment of the present invention, contextual search interface 1200 comprises, for example, the following sections: (a) search query section 1210; (b) segmentation filtering section 1212; (c) spatial filtering section 1214; and (d) target local market section 1216. In turn, according to another embodiment of the present invention, the search query section 1210 comprises, for example: search query combo-box 1218, enabling the consumer to input data, for example, by means of the mobile device keypad, QWERTY™ keyboard, touch screen, voice receiver, voice recognition application, camera and image processing applications, RF tag receiver, etc. It should be noted that the contextual corrected/completed search queries, according to the contextual local search method 1100 (FIG. 11), are displayed to the consumer in a search query list 1224. In addition, the search query section 1210 comprises the following search query execution buttons: textual result button 1220 for presenting textual hyperlink list, wherein each item within the list is related to a specific search query result; and spatial result button 1222 for determining each search query item by using the contextual shopping map interface 1300 (FIG. 13).

According to still another embodiment of the present invention, the segmentation filtering section 1212 enables the consumer to determine the segmentation filtering according to the contextual local search method 1100 (FIG. 11). According to an embodiment of the present invention, the selected target local market segment of the consumer's search query is determined according to the data provided within target segment combo box 1224, and target segment sub-categories combo box 1226, representing sub-categories of the selected target segment. It should be noted that, according to an embodiment of the present invention, the market segment combo box 1224 lists one or more valid segments, which are related to the search query keywords, according to the contextual local search method 1100 (FIG. 11).

According to still another embodiment of the present invention, the spatial filtering section 1214 enable the consumer to determine the desired local market areas, according to the contextual local search method 1100 (FIG. 11). According to an embodiment of the present invention, the consumer might click on the local market area button 1230, and as a result the contextual shopping map interface 1300 (FIG. 13) will appear on the consumer's mobile device 120 (FIG. 1) screen. In turn, the consumer may select a particular map and region, which represents the desired local market area. As a result, the local market area display 1232 is updated according to the selected region (area) provided by means of the contextual shopping map interface 1300.

According to a further embodiment of the present invention, the target market section 1216 enables the consumer to select the target market area with regard to the search query. The consumer clicks on the target local market button 1234, and as a result, a local market interface (not shown) may be displayed on the consumer device 120 screen. After the target local market is selected by mean of this interface, the target local market display 1236 is updated. It should be noted that the target market section 1216 can be update automatically by means of Locator unit 142 (FIG. 1).

According to an embodiment of the present invention, the relevant selected targeted content can be provided by means of the contextual search query interface 1200 as well as contextual search query result interface (not shown) in order to assist the consumer to reduce a scope of the search results. According to an embodiment of the present invention, the relevant selected targeted content can be, for example, as follows: (a) relevant product/service attributes; (b) relevant brands; (c) relevant sale promotion messages, such as relevant coupons, relevant vouchers, relevant price reductions; (d) selected virtual cart items. Also, one or more relevant selected targeted content 1219(a), 1219(b) can be provided in proximity with one or more search query combo-box 1218 elements. Similarly, one or more relevant recommendations 1225(a), 1225(b) can be attached to one or more target segment combo box 1224 elements. Analogically, one or more relevant selected targeted content 1227(a), 1227(b) can be provided in proximity with one or more sub-category 1226 elements.

It is supposed, for example, that a consumer of “Mall M” (of a particular local market) is looking for an item related to “women fashion”, and he said consumer conducts a search by means of mobile device 120 (FIG. 1) by using the keywords {“Wo”; “Fashion”}. The Local Market Search Engine unit 150 (FIG. 1) receives and processes the above keywords as well as the targeted local market identification, which is provided automatically by Locator unit 142 (FIG. 1). In turn, Local Market Search Engine unit 150 determines whether, for example: (a) the above keywords have to be either corrected or completed according to step 1114 (FIG. 11); (b) all the above keywords are associated with a valid segmentation path, according to contextual query validity step 1116 (FIG. 11). It should be noted that a single combination of search keywords may be associated with more than one segmentation path. In turn, the keywords that maximally (optimally) match the above points (a) and (b), such as (“Fashion”, “Women”), are displayed to the consumer within search query list 1218(a). Then the consumer may select the term “fashion women” from search query list 1218(a). As a result, the target segment list 1224(a) is updated according to segmentation paths that are related to the selected keywords: “fashion women”. After that, the consumer may select the desired segmentation path from the list 1224(a), such as selecting the “Fashion Women Clothing” keywords, thereby reducing the scope of search results. Similarly, the consumer may select the “Shirts” sub-category 1226(a), further narrowing the scope of search results. In addition, the consumer may further narrow the search results scope by reducing the target spatial space of the search. Thus, the consumer may set the desired local market area 1232 to “Building A, 3^{rd} Floor”. So, the search results become limited only to “Fashion Women Clothing Shirts at Building A, 3rd Floor”.

FIG. 13 presents a sample illustration of contextual shopping map interface 1300 for enabling consumers to obtain selected targeted content with regard to a particular local market area as well as enabling acquiring each consumer's selections, according to an embodiment of the present invention. According to this embodiment, the contextual shopping map interface 1300 comprises, for example: contextual map section 1310; spatial search control section 1312. The contextual map section 1310 may comprise: digital orientation maps, which are drawings of complete or partial local market areas containing building floors 318 (FIG. 3), open spaces 314 (FIG. 3), local advertiser interiors areas 330 (FIG. 3), etc. These drawings are covered by layered data (e.g., cell layers) and by various data objects, which are represented by a plurality of textual formats, graphic figures, and images. According to an embodiment of the present invention, the data objects represent a local market area of semantic network 400 containing, for example, local points of sale/shop areas 1314, local market facilities areas 1316 (e.g., for general purposes), locations of products or points of service 1316, etc.

According to an embodiment of the present invention, the contextual shopping map interface 1300 enables presenting to the consumer relevant selected targeted content indications over the shopping map 1310, which are updated continuously and substantial in real time. These indications can be represented by text 1320, graphics 1322, images 1324, audio and/or video data, and the like. For example, relevant selected target content may contain the following information: a name of a specific point of sale (POS), emphasized POS area background, product images, sale promotion images (such as coupon and sale icons). The relevant selected targeted content can be related, for example, to the following: (a) relevant product/service attributes; (b) relevant point of sales; (c) relevant brands; (d) relevant sale promotion messages (such as relevant coupons, relevant vouchers, relevant price reductions); (e) selected virtual cart items.

Also, according to an embodiment of the present invention, the relevant selected targeted content can be related to local market items, which are positioned on the shopping area displayed to the consumer within shopping map section 1310, or which are positioned within other shopping areas (in such a case, the relevant selected targeted content 1328 is presented near the suggested shopping path 1326).

According to another embodiment of the present invention, the consumer can operate contextual shopping map 1300 interface by selecting either automatic or manual display mode. The automatic display mode enable displaying the corresponding local market map region according to the consumer's current position 1330, which can be determined by Locator unit 142 (FIG. 1). On the other hand, the manual display mode enables the consumer to select desired local market regions independently of his current present position 1330.

According to still another embodiment of the present invention, the consumer can pull the selected targeted content by pointing and pressing on the corresponding relevant indications within the shopping map interface 1300. As a result, the target content exposure interface (FIG. 14) appears on the screen of the consumer's mobile device 120 (FIG. 1), presenting the selected targeted content to the consumer.

It should be noted that the consumer can select a type of the selected targeted content to be presented by shopping map interface 1300. Such types may be “personal selected targeted content” 820(a) (FIG. 8A), “most popular selected targeted content” 820(b) (FIG. 8A), combined personal and most popular selected targeted content 820(c) (FIG. 8A); “most new selected targeted content” 820(d) (FIG. 8A); “friend-based selected targeted content” 820(e) (FIG. 8A). For example, a consumer who wants to determine products/services, which optimally match his preferences, may select a “personal selected targeted content” mode along with the above automatic display mode.

According to an embodiment of the present invention, a consumer can conduct a spatial search (by using spatial search control section 1312) with regard to a particular area within the local market. For example, a consumer may conduct a spatial search for the term “sport shoes” with regard to the shopping area presented in FIG. 13. As a result, at least one hyperlink objects, which is associated with relevant target content (such as sport shoes advertisement or sport shoes coupon 1324), appears on the shopping map. In turn, the consumer can be exposed to the relevant targeted content by pressing on the hyperlinked object.

According to an embodiment of the present invention, the system is capable to locate a targeted content object location. This can be done by using navigation services provided by means of targeted content exposure interface (FIG. 14). As a result, contextual shopping map interface 1300 appears on a screen of consumer's mobile device 120. Then, a shortest path 1326 (from local market point 1330, which could be the consumer's present location, to the targeted content object location) is displayed on the map. It should be notated that a similar navigation path can be displayed from any local market point to more than one contextual shopping map objects.

FIG. 14 presents targeted content exposure interface 1400 for enabling consumers to expose the targeted content and context data, and for enabling acquiring data that indicate consumers' selections, according to an embodiment of the present invention. According to this embodiment of the present invention, the targeted content exposure interface 1400 comprises: a Content Viewer 1410 for viewing/playing various data, such as images, video/audio, text and graphic drawing, and the like; and a plurality of user interface (UI) services. In addition, targeted content exposure interface 1400 provides the consumer with the complementary contextual data as well with the access to complementary services with regard to the displayed targeted content 1412.

According to an embodiment of the present invention, the “Personal Rank” display 1420 presents a matching level between contextual consumer preferences (generated at step 816 of FIG. 8A) and the displayed targeted content, according to the analysis of said contextual consumer preferences. For example, if the presented targeted content is related to sport shoes, and the consumer is seeking for boots, then the corresponding rank level can be defined (calculated by system 100 (FIG. 1)) as “moderate”. Similarly, the “Popularity Rank” 1422 display indicates a matching level between the consumer community preferences (generated at step 818 of FIG. 8A) and the displayed targeted content, according to the analysis of said consumer community preferences.

For example, the service of “Consumers Who Like This Also Like . . . ” 1424 enables a consumer to expose other targeted content data related to the displayed targeted content based on the analysis of the consumer community preferences and based on the semantic network 400 (FIG. 4) objects and contextual links.

According to an embodiment of the present invention, the availability of the displayed targeted content is indicated over the “Availability” display 1426. The availability data can be updated either manually or automatically, and the update status of the displayed targeted content is indicated over the “Update To: (Date)” display 1428. Also, the “Attributes” services 1430 enable a consumer to view a plurality of attributes related to the presented targeted content as defined by the advertiser (e.g., price, product functionality, color, size), as determined at step 616 of FIG. 6). In addition, the local market segmentation of the displayed targeted content can be accessed by the using the “Categories” 1436 directory service, which is based on the local marketing environment group 410 (FIG. 4) objects and links of the semantic network 400. Further, the “Friend Comments” display 1438 lists the consumer's friends comments with regard to the displayed target content, which is based on targeted content data exchanges between friends Thus, for example, a consumer can consult a friend prior to making any purchase decision.

According to an embodiment of the present invention, the consumer can surf to the advertiser's web site associated with the displayed targeted content by using “Web site” service 1440. (in turn, a “Web Site Hit” 912 (FIG. 9) is generated). Similarly, the consumer can retrieve general information related to the displayed targeted content (such as the provider name and opening hours) by using “General Info” service 1440 (in turn, a “General Info Hit” 913 (FIG. 9) is generated). Also, the consumer can call a particular local provider with regard to the displayed targeted content by using “Phone Call” service 1444 (in turn, the consumer's mobile device 120 (FIG. 1) dials automatically the advertiser, thereby generating a “Phone Call Hit” 913 (FIG. 9)).

According to another embodiment of the present invention, the system 100 is capable to provide virtual shopping cart services for consumers by means of a (virtual) shopping cart interface (FIG. 13), which enables the consumer to preserve selected targeted content for a further use. The consumer can either select or deselect the presented targeted content by using the “Shopping Cart” 1446 services (The system 100 generates a “Shopping Cart Hit” 915 (FIG. 9) each time a particular consumer selects a new targeted content and moves it to the virtual shopping cart. Further, each time a purchase form related to the displayed targeted content is submitted by the consumer by using the “Purchase/Reserve” service 1448, then a “Purchase Form Hit” 917 (FIG. 9) or a “Reserve Hit” 916 (FIG. 9) are generated, respectively. According to still another embodiment of the present invention, when a consumer uses a “Send To Friend” service 1450, the following activities are executed: a targeted data reference is sent to the consumer's friend, according to the method presented in FIG. 10; and in turn, a “Viral Hit” 918 (FIG. 9) is generated.

According to an embodiment of the present invention, a consumer is also able to expose a plurality of related targeted content, which are associated with the presented targeted content according to the relation links provided by the advertiser (at step 624 of FIG. 6). For example, the consumer can seek for the additional information with regard to the targeted content, such as digital coupons, sales discounts or brand names. This can be done by using “Related Items” service 1452, which causes system 100 to generate a “Related Item Hit” 919 (FIG. 9). In addition, a consumer can determine and navigate to the displayed target content object (product/service) by using “Locate & Navigate” service 1454, which is a location based service (LBS) provided by system 100. Further, the “General Info” service 1442 enables to provide any general information to the consumer (e.g., with regard to a particular product/service).

It should be noted that consumers can further share between them various shopping information as follows, for example:
share targeted content and/or POS links;
share links related to the various regions of interest of the predefined shopping site;
share local market segmentation paths;
advertiser's general information and related information provided within the predefined physical site;
cds

Thus, for example, if a consumer is impressed by a woman dress at a particular local market (particular shopping mall), then said consumer can relatively easily share her friends with all POS' within said particular local market that are related to said woman dress. This can be performed by communicating with the friends and conveying them a link (pointer) to either the whole “clothing” sector/category or to a particular sub-category related to woman “dresses”, or alternatively, to a specific POS (e.g., located on the 2^{nd} floor of the predefined local market) which sells woman dresses.

Also, it should be noted that the content of the (virtual) shopping cart can be also shared between consumers in the form of a list, tree, dictionary, and the like.

FIG. 15 is a schematic flow-cart 1500 for determining targeted advertising campaign performances, according to an embodiment of the present invention. According to this embodiment of the present invention, the campaigns can be assessed and controlled by advertiser based on the analysis of contextual links among a plurality of data sources related to the outcomes of the targeted publishing method. The analyzing of the targeted campaign can be made by using an advertiser device 126 (FIG. 1) and by using Contextual Advertiser's Report Unit 154 (FIG. 1). According to an embodiment of the present invention, providing of the targeted campaign report comprises the following steps: (a) step 1520 (and corresponding sub-steps 1522 to 1530) for determining attributes and scope of the targeted campaign report ; (b) step 1532 (and corresponding sub-steps 1534 to 1538) for retrieving and integrating related internal data from the Local Market Server Cluster (LMSC) 101 (FIG. 1); (c) step 1540 (and corresponding sub-steps 1542 and 1544) for importing and integrating related external data that can be imported (either automatically or manually) from other external system(s), which can be accessed by the advertiser; (d) step 1550 (and corresponding sub-steps 1552 to 1556) for analyzing related data sources and contextual links among these sources; and (e) step 1560 for providing targeted campaign reports.

According to an embodiment of the present invention, the determining of the attributes and scope of the targeted campaign report at step 1520 comprises: (a) step 1522 for enabling subscribed brand advertisers 430 (FIG. 4) to set a scope of the report by selecting one or more related targeted local markets (e.g., to include local markets “M1”, “M2” and exclude the local market “M3”); (b) step 1524 for enabling the subscribed advertisers 414 (FIG. 4) to restrict the report by selecting market segmentations/categories in each selected targeted market, according to objects and links of semantic network 400 (FIG. 4) (e.g., to include “women shoes” and exclude “evening women shoes”); (c) step 1526 for enabling subscribed advertisers 414 to restrict the report by selecting targeted content items 418 (FIG. 4) (e.g., to include only “teenagers sport shoes” advertisements); (d) step 1528 for enabling subscribed brand advertisers 430 (FIG. 4) to restrict the report by selecting related local advertisements in each selected targeted market, according to objects and links of semantic network 400 (for example, the subscribed publisher “GP1”, which is related to the local advertisers “LP1” and “LP2” at local market “M” may wish to focus the report only to the targeted content related to “LP1”); (e) step 1530 for enabling subscribed advertisers 414 to restrict the report by setting a desired time period (e.g., a day, week, month, etc.).

According to another embodiment of the present invention, the retrieving and integrating of the related internal data, at step 1532, comprising: (a) step 1534 for retrieving and integrating semantic network objects related to the report scope and attributes provided from semantic network databases 160 (FIG. 1); (b) step 1536 for retrieving and integrating consumer's preferences objects related to the report scope and attributes provided from the consumers' preferences databases 162 (FIG. 1); (c) step 1534 for retrieving and integrating semantic network objects that are related to the report attributes and scope provided from the semantic network databases 160. It should be noted that the above internal data is integrated at steps 1536 and 1538, which means that the semantic network 400 (FIG. 4) objects are integrated with both consumer's preferences data and advertiser's targeted campaign billing data, which are retrieved from consumers' preferences database 162 and advertiser's database 163 (FIG. 1), respectively.

According to still another embodiment of the present invention, the importing of the related external data, at step 1532, is optional, and the importing can be performed either manually by the advertiser or automatically by establishing, for example, a data communication interface the between advertiser's device 126 (FIG. 1) and external advertiser's systems (not shown) over a data network 148 (FIG. 1). According to an embodiment of the present invention, at step 1532, the internal and external data are integrated, i.e. targeted content objects 418 (FIG. 4) are associated to sales data objects and vise-versa.

According to a further embodiment of the present invention, the importing and integrating the related external data comprises: step 1542 for importing and integrating related sales data; and step 1544 for importing and integrating related inventory data.

According to still a further embodiment of the present invention, step 1550 enables performing a targeted campaign analysis based on the processing of the related internal/external data and the corresponding contextual links among this data. According to this embodiment of the present invention, the targeted campaign analysis comprises: (a) step 1552 for analyzing market response indexes and trends, thereby calculating and generating various market response metrics, which can be further used by advertisers to improve, for example, the cost-effectiveness of their targeted advertising campaigns; (b) step 1554 for analyzing consumer groups; and (c) step 1556 for analyzing various targeted campaign cost-effectiveness factors. The market response indexes and trends (i.e. the market response metrics) can be calculated by performing, for example, statistical calculations of consumer's preferences with regard to semantic network objects relations and local market time. This analysis can yield a plurality of market response indexes, such as market awareness share of particular advertiser's products related to a particular segment of a particular local market. In addition, the market response trends can be calculated based on these market response indexes. According to an embodiment of the present invention, the consumer groups can be obtained by identifying common contextual relations between semantic network objects 400 (FIG. 4) and particular consumer's preference data. These groups may assist the advertiser to identify more precisely their targeted consumers. For example, the system 100 may identify a significant consumer group that mostly prefers particular market segments. Also, the analyzing of the various cost-effectiveness factors can be provided by cross-correlating the calculated market response indexes with corresponding targeted campaign billing data. For example, by using these analysis outcomes, the advertisers can assess their return on investments (ROD and more precisely determine their optimal targeted marketing strategy. Further, at step 1560, a plurality of reports that are based on the outcomes of the targeted campaign analysis are presented to the advertiser.

It should be noted that the contextual local marketing information can be further integrated with the contextual local spatial information in order to provide more detailed market response. For example, it can be supposed that the local market segmentation path Teenagers->Sport->Shoes that is related to a particular advertiser is distributed by POS 1 (not shown) at one local market (Market 1). In addition, the same local market segmentation path of the same advertiser is also distributed by POS 2 (not shown) at another local market (Market 2). It is supposed that by analyzing the above two campaigns (at Markets 1 and 2), which can be made by using an advertiser device 126, the advertiser determines that the local market response at Market 1 is lower than the local market response at Market 2, which means that the advertising campaign at Market 2 is more successful. Then, by identifying and analyzing all factors that may have an influence on the advertising campaign success (e.g., POS 2 is located in proximity to another POS that is very popular among teenagers), the advertiser may improve the cost-effectiveness of his advertising campaigns.

In addition, it should be noted that according to a further embodiment of the present invention, various metrics of semantic network 400 (FIG. 4) can be inherited (transferred) between nodes of each segmentation path or between nodes of different segmentation paths, such as segmentation paths 440′, 440″, etc (FIG. 7C). Each node may represent a category, such as “clothing”, or a sub-category, such as “dresses”, If a node represents a category, such a node is a high-level node, and if a node represents a sub-category, then such a node is a low-level node. As a result, the metrics can be inherited between the high-level and low-level nodes. For example, it is supposed that one node represents a “clothing” category, and other three nodes represent “shoes”, “dresses” and “hats” sub-categories. If a consumer performed various actions with regard to one or more sub-categories, such as: sends a EMAIL, SMS (Short Messaging Service) to his friend with a link to the particular POS, within the predefined physical site (e.g., shopping mall), which sells hats; and/or spends a certain period of time (e.g., three hours) at the shoes store looking to shoes for his wife, then such metrics are transferred (inherited) to the higher-level category (i.e. the “clothing” category), thereby enabling to obtain an overall metrics of the “clothing” segment/field. Then, advertisers can receive corresponding market response/statistical reports with regard to either low-level nodes or higher-level nodes of the semantic network 400.

It should be noted that in order to perform (execute) various methods of the present invention, a program storage (memory) device readable by machine can be provided, which further tangibly embodies a program of instructions (program code) executable by the machine.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes;
b) providing at least one metrics to a node from said at least two nodes;
c) inheriting said at least one metrics from said node to a higher-level node from among said at least two interconnected nodes; and
d) providing a local targeted advertising campaign with regard to at least one predefined physical site based on said inheriting of said at least one metrics.

2. The method according to claim 1, further comprising defining the semantic network by the following:
a) providing a spatial structure of physical locations of a plurality of entities within the predefined physical site;
b) providing a marketing environment of said predefined physical site, said marketing environment comprising data related to one of advertisements and sale promotions provided within said predefined physical site; and
c) providing a plurality of advertisers, which enable to interlink between said spatial structure with said marketing environment.

3. The method according to claim 2, wherein the spatial structure comprises at least one of the following:
a) a building;
a) a building floor;
b) open spaces;
c) cells;
d) cell layers; and
e) walking paths.

4. The method according to claim 2, wherein the local marketing environment comprises at least one of the following:
a) a plurality of targeted content data objects; and
b) a plurality of category objects.

5. The method according to claim 2, wherein the advertiser is related to at least one of the following:
a) a point of sale provider;
b) a service provider;
c) a product provider;
d) an advertising campaign provider; and
e) a local market operator.

6. The method according to claim 1, wherein the semantic network is dynamically updated.

7. The method according to claim 1, wherein the predefined physical site is a predefined shopping site.

8. The method according to claim 7, further comprising assigning each consumer with a unique identification number (ID), when said anonymous consumer connects to the predefined shopping site over the semantic network, thereby enabling said consumer to remain the anonymous consumer of said predefined shopping site.

9. The method according to claim 8, further comprising calculating the at least one metrics with regard to the behavior of the anonymous consumer who is connected to the predefined shopping site.

10. The method according to claim 7, further comprising calculating the at least one metrics with regard to a group of consumers of the predefined shopping site.

11. The method according to claim 2, further comprising providing at least one report to the plurality of advertisers with regard to the at least one calculated metrics.

12. The method according to claim 7, further comprising analyzing the a result of the at least one calculated metrics for determining a plurality of factors that influenced on said result, said factors comprising:
a) the location of the predefined physical site;
b) the location the point-of-sale (POS) within said predefined physical site;
c) the location of a particular region of each point-of-sale;
d) the spatial structure of said predefined physical site;
e) at least one targeted content item provided at the predefined physical site;
f) the location of a product or service related to at least one target content item provided within the predefined physical site;
g) a category of said targeted content item; and
h) the calendar time interval, to which the metrics is related.

13. The method according to claim 12, further comprising providing at least one report to the plurality of advertisers with regard to the analyzing of the result of the at least one metrics.

14. The method according to claim 13, further comprising providing the at least one report substantially in real-time.

15. The method according to claim 14, further comprising informing a plurality of consumers regarding a sale promotion for one of at least one product and service substantially in real-time.

16. The method according to claim 2, further comprising enabling to compare a plurality of metrics with regard to the semantic network and with regard to the at least one predefined physical site.

17. The method according to claim 1, wherein the metrics is selected from at least one of the following:
a) a statistical metrics;
b) a segmentation path rank metrics;
c) a personal consumer preferences rank metrics;
d) a consumer community preference rank metrics;
e) a target distance metrics; and
f) a market response metrics.

18. The method according to claim 1, further comprising providing the effectiveness rank of the local targeted campaign based on the at least one metrics.

19. A method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes, said semantic network defined by:
a.1. providing a spatial structure of physical locations of a plurality of entities within said predefined physical site;
a.2. providing a marketing environment of said predefined physical site, said marketing environment comprising data related to one of advertisements and sale promotions provided within said predefined physical site; and
a.3. providing a plurality of advertisers, which enable to interlink between said spatial structure with said marketing environment;
b) defining each node within said at least two interconnected nodes as one of a category, giving rise to a higher-level node, and a sub-category, giving rise to a lower-level node;
c) calculating the at least one metrics of the targeted advertising campaign by utilizing said semantic network, while providing at least one metrics to a node from said at least two nodes and inheriting said at least one metrics from said node to a higher-level node from among the at least two interconnected nodes; and
d) providing a local targeted advertising campaign with regard to the at least one predefined physical site based on the inheriting of said at least one metrics.

20. The method according to claim 19, wherein the spatial structure comprises at least one of the following:
a) a building;
b) a building floor;
c) open spaces;
d) cells;
e) cell layers; and
f) walking paths.

21. The method according to claim 19, wherein the local marketing environment comprises at least one of the following:
a) a plurality of targeted content data objects; and
b) a plurality of category objects.

22. The method according to claim 19, wherein the advertiser is related to at least one of the following:
a) a point of sale provider;
b) a service provider;
c) a product provider;
d) an advertising campaign provider; and
e) a local market operator.

23. The method according to claim 19, wherein the semantic network is dynamically updated.

24. The method according to claim 19, wherein the predefined physical site is a predefined shopping site.

25. The method according to claim 24, further comprising assigning each consumer with a unique identification number (ID), when said anonymous consumer connects to the predefined shopping site over the semantic network, thereby enabling said consumer to remain the anonymous consumer of said predefined shopping site.

26. The method according to claim 25, further comprising calculating the at least one metrics with regard to the behavior of the anonymous consumer who is connected to the predefined shopping site.

27. The method according to claim 24, further comprising calculating the at least one metrics with regard to a group of consumers of the predefined shopping site.

28. The method according to claim 19, further comprising providing at least one report to the plurality of advertisers with regard to the at least one calculated metrics.

29. The method according to claim 19, further comprising analyzing the a result of the at least one calculated metrics for determining a plurality of factors that influenced on said result, said factors comprising:
a) the location of the predefined physical site;
b) the location the point-of-sale (POS) within said predefined physical site;
c) the location of a particular region of each point-of-sale;
d) the spatial structure of said predefined physical site;
e) at least one targeted content item provided at the predefined physical site;
f) the location of a product or service related to at least one target content item provided within the predefined physical site;
g) a category of said targeted content item; and
h) the calendar time interval, to which the metrics is related.

30. The method according to claim 29, further comprising providing at least one report to the plurality of advertisers with regard to the analyzing of the result of the at least one metrics.

31. The method according to claim 30, further comprising providing the at least one report substantially in real-time.

32. The method according to claim 31, further comprising informing a plurality of consumers regarding a sale promotion for one of at least one product and service substantially in real-time.

33. The method according to claim 19, further comprising enabling to compare a plurality of metrics with regard to the semantic network and with regard to the at least one predefined physical site.

34. The method according to claim 19, wherein the metrics is selected from at least one of the following:
a) a statistical metrics;
b) a segmentation path rank metrics;
c) a personal consumer preferences rank metrics;
d) a consumer community preference rank metrics;
e) a target distance metrics; and
f) a market response metrics.

35. The method according to claim 1, further comprising providing the effectiveness rank of the local targeted campaign based on the at least one metrics.

36. A method of enabling to perform a consolidation with regard to a predefined physical site, said method comprising:
a) providing a semantic network having a plurality of segmentation paths, wherein each segmentation path is related to a predefined physical site and includes at least two interconnected nodes;
b) determining at least two similar segmentation paths within said semantic network, according to at least one predefined criterion; and
c) performing a consolidation of at least two nodes of each of said at least two similar segmentation paths, based on said predefined criterion, giving rise to at least one consolidated segmentation path.

37. The method according to claim 36, wherein the at least one predefined criterion relates to at least one of the following:
a) a typo error;
b) a marketing filtering; and
c) a praise words usage.

38. The method according to claim 37, wherein the marketing filtering relates to the filtering of at least two similar market segments.

39. The method according to claim 36, further comprising defining the semantic network by the following:
a) providing a spatial structure of physical locations of a plurality of entities within the predefined physical site;
b) providing a marketing environment of said predefined physical site, said marketing environment comprising data related to one of advertisements and sale promotions provided within said predefined physical site; and
c) providing a plurality of advertisers, which enable to interlink between said spatial structure with said marketing environment.

40. The method according to claim 39, wherein the spatial structure comprises at least one of the following:
a) a building;
b) a building floor;
c) open spaces;
d) cells;
e) cell layers; and
f) walking paths.

41. The method according to claim 39, wherein the local marketing environment comprises at least one of the following:
a) a plurality of targeted content data objects; and
b) a plurality of category objects.

42. The method according to claim 39, wherein the advertiser is related to at least one of the following:
a) a point of sale provider;
b) a service provider;
c) a product provider;
d) an advertising campaign provider;
e) a local market operator.

43. The method according to claim 36, wherein the semantic network is dynamically updated.

44. The method according to claim 36, further comprising calculating at least one metrics of at least one of the following:
a) at least one segmentation path;
b) at least one consolidated segmentation path;
c) at least one node of said at least one segmentation path; and
d) at least one node of said at least one consolidated segmentation path.

45. The method according to claim 44, further comprising inheriting the at least one metrics between nodes of each segmentation path.

46. The method according to claim 36, wherein the nodes of each segmentation path form a hierarchical structure.

47. The method according to claim 36, wherein each node of the each segmentation path is one of the following:
a) a category, thereby the node as a higher-level node; and
b) a sub-category, thereby the node as a lower-level node.

48. The method according to claim 47, further comprising performing the consolidation of one of the category and sub-category.

49. The method according to claim 36, further comprising removing the segmentation paths which are at least one of the following:
a) not used for a predefined period of time;
b) are determined as redundant; and
c) are determined as non-effective.

50. A server configured to perform at least one metrics of a targeted advertising campaign by utilizing a semantic network with regard to a predefined physical site, said server comprising:
a) a local network database configured to store a semantic network that comprises a plurality of segmentation paths, wherein each segmentation path is related to a predefined physical site and includes at least two interconnected nodes, and wherein said semantic network is defined by:
a.1. a spatial structure of physical locations of a plurality of entities within said predefined physical site;
a.2. a marketing environment of said predefined physical site, said marketing environment comprising data related to one of advertisements and sale promotions provided within said predefined physical site; and
a.3. a plurality of advertisers, which enable to interlink between said spatial structure with said marketing environment; and
b) a targeted campaign analyzing unit configured to enable the advertisers to assess and control their advertising campaigns, and enabling to calculate at least one metrics of the targeted advertising campaign over said semantic network.

51. The server according to claim 50, wherein the spatial structure comprises at least one of the following:
a) a building;
b) a building floor;
c) open spaces;
d) cells;
e) cell layers; and
f) walking paths.

52. The server according to claim 50, wherein the local marketing environment comprises at least one of the following:
a) a plurality of targeted content data objects; and
b) a plurality of category objects.

53. The server according to claim 50, wherein the advertiser is related to at least one of the following:
a) a point of sale provider;
b) a service provider;
c) a product provider;
d) an advertising campaign provider; and
e) a local market operator.

54. The server according to claim 50, further comprising a search engine unit configured to enable conducting a search for at least one item over the semantic network.

55. The server according to claim 50, further comprising a locator unit configured to acquire locations of consumers' mobile devices.

56. The server according to claim 55, wherein the locator unit further is configured to identify anonymous consumers based on the acquired locations.

57. The server according to claim 50, further comprising a data acquiring unit configured to gather targeting information provided by a plurality of advertisers.

58. The server according to claim 57, wherein the data acquiring unit further processes and integrates the targeting information within the local network database.

59. The server according to claim 50, further comprising a shopping map unit configured to provide contextual information to a plurality of consumers by using location base services (LBS).

60. The server according to claim 50, further comprising a local content exposure unit configured to enable a plurality of consumers to operate the contextual information.

61. The server according to claim 50, further comprising a consumer preference unit configured to perform at least one of the following:
a) gather selections of each consumer, which are made by the mobile device of said each consumer, giving a rise to the gathered consumer selections;
b) analyze the gathered consumer selections and transform these selections to one or more consumer preferences; and
c) store said consumer preferences within a consumers preferences database.

62. The server according to claim 50, further comprising a targeted campaign monetization unit configured to monetize targeted campaigns by measuring traffic of the contextual information.

63. The server according to claim 50, further comprising an advertisers' database configured to store advertisers' details for managing and billing the advertisers' accounts.

64. The server according to claim 50, further comprising a local schedule unit for enabling synchronizing at least a portion of units, which are one of provided and connected to said server.

65. The server according to claim 50, wherein the metrics is selected from at least one of the following:
a) a statistical metrics;
b) a segmentation path rank metrics;
c) a personal consumer preferences rank metrics;
d) a consumer community preference rank metrics;
e) a target distance metrics; and
f) a market response metrics.

66. The server according to claim 50, wherein said server further enables to:
a) provide the at least one metrics to a node from the at least two nodes; and
b) inherit said at least one metrics from said node to a higher-level node from among said at least two interconnected nodes.

67. A system configured to provide a local targeted advertising campaign with regard to at least one predefined physical site , said system comprising at least one server of claim 50.

68. The system according to claim 67, further comprising a remote consumer services apparatus configured to enable connecting mobile devices of a plurality of consumers to the at least one server.

69. The system according to claim 67, further comprising a remote advertiser services apparatus configured to enable connecting devices of a plurality of advertisers to the at least one server.

70. A method of awarding a consumer based on the consumer's activity with regard to a predefined physical site, said activity performed by means of the consumer's mobile device, said method comprising:
a) providing a semantic network having a plurality of segmentation paths, wherein each segmentation path is related to a predefined physical site and includes at least two interconnected nodes, while each node within said at least two interconnected nodes is one of a category, giving rise to a higher-level node, and a sub-category, giving rise to a lower-level node;
b) enabling the consumer to perform an activity with regard to said predefined physical site and said semantic network; and
c) award said consumer based on said activity.

71. The method according to claim 70, wherein the awarding of the consumer is performed by an advertiser.

72. The method according to claim 70, wherein the activity is related to with the semantic network and to the predefined physical site.

73. The method according to claim 70, wherein the awarding comprises providing to the consumer at least one of the following:
a) a coupon;
b) a discount;
c) a voucher; and
d) a gift.

74. The method according to claim 70, further comprising defining the semantic network by the following:
a) providing a spatial structure of physical locations of a plurality of entities within the predefined physical site;
b) providing a marketing environment of said predefined physical site, said marketing environment comprising data related to one of advertisements and sale promotions provided within said predefined physical site; and
c) providing a plurality of advertisers, which enable to interlink between said spatial structure with said marketing environment.

75. The method according to claim 74, wherein the spatial structure comprises at least one of the following:
a) a building;
b) a building floor;
c) open spaces;
d) cells;
e) cell layers; and
f) walking paths.

76. The method according to claim 74, wherein the local marketing environment comprises at least one of the following:
a) a plurality of targeted content data objects; and
b) a plurality of category objects.

77. The method according to claim 74, wherein the advertiser is related to at least one of the following:
a) a point of sale provider;
b) a service provider;
c) a product provider;
d) an advertising campaign provider; and
e) a local market operator.

78. The method according to claim 70, wherein the semantic network is dynamically updated.

79. The method according to claim 70, further comprising assigning each consumer with a unique identification number (ID), when said anonymous consumer is connected the predefined shopping site over the semantic network, thereby enabling said consumer to remain the anonymous consumer of said predefined shopping site.

80. The method according to claim 79, further comprising calculating the at least one metrics with regard to the behavior of the anonymous consumer within the predefined shopping site.

81. The method according to claim 80, wherein the metrics is selected from at least one of the following:
a) a statistical metrics;
b) a segmentation path rank metrics;
c) a personal consumer preferences rank metrics;
d) a consumer community preference rank metrics;
e) a target distance metrics; and
f) a market response metrics.

82. The method according to claim 70, further comprising calculating the at least one metrics with regard to a group of consumers of the predefined shopping site.

83. The method according to claim 80, further comprising providing at least one report to the plurality of advertisers with regard to the at least one calculated metrics.

84. The method according to claim 80, further comprising analyzing the a result of the calculated at least one metrics for determining a plurality of factors that influenced on said result, said factors comprising:
a) the location of the predefined physical site;
b) the location the point-of-sale (POS) within said predefined physical site;
c) the location of a particular region of each point-of-sale;
d) the spatial structure of said predefined physical site;
e) at least one targeted content item being sold within the predefined physical site;
f) a category of said targeted content item; and
g) the calendar time interval, to which the metrics is related.

85. The method according to claim 84, further comprising providing at least one report to the plurality of advertisers with regard to the analyzing of the result of the at least one metrics.

86. The method according to claim 85, further comprising providing the at least one report substantially in real-time.

87. The method according to claim 86, further comprising awarding the consumer substantially in real-time.

88. A program storage device readable by machine, tangibly embodying a program of instructions executable by the machine to perform a method of providing a local targeted advertising campaign with regard to at least one predefined physical site said method comprising:
a) providing a semantic network having a plurality of segmentation paths, wherein each segmentation path is related to a predefined physical site and includes at least two interconnected nodes;
b) providing at least one metrics to a node from said at least two nodes;
c) inheriting said at least one metrics from said node to a higher-level node from among said at least two interconnected nodes; and
d) providing a local targeted advertising campaign with regard to at least one predefined physical site based on said inheriting of said at least one metrics.

89. A program storage device readable by machine, tangibly embodying a program of instructions executable by the machine to perform a method of providing a local targeted advertising campaign with regard to at least one predefined physical site, said method comprising:
a) providing a semantic network having a plurality of segmentation paths, wherein each segmentation path is related to a predefined physical site and includes at least two interconnected nodes, said semantic network defined by:
a.1. providing a spatial structure of physical locations of a plurality of entities within said predefined physical site;
a.2. providing a marketing environment of said predefined physical site, said marketing environment comprising data related to one of advertisements and sale promotions provided within said predefined physical site; and
a.3. providing a plurality of advertisers, which enable to interlink between said spatial structure with said marketing environment;
b) defining each node within said at least two interconnected nodes as one of a category, giving rise to a higher-level node, and a sub-category, giving rise to a lower-level node;
c) calculating the at least one metrics of the targeted advertising campaign by utilizing said semantic network, while providing at least one metrics to a node from said at least two nodes and inheriting said at least one metrics from said node to a higher-level node from among the at least two interconnected nodes; and
d) providing a local targeted advertising campaign with regard to the at least one predefined physical site based on the inheriting of said at least one metrics.

90. A program storage device readable by machine, tangibly embodying a program of instructions executable by the machine to perform a method of enabling to perform a consolidation with regard to a predefined physical site, said method comprising:
a) providing a semantic network having a plurality of segmentation paths, wherein each segmentation path is related to a predefined physical site and includes at least two interconnected nodes;
b) determining at least two similar segmentation paths within said semantic network, according to at least one predefined criterion; and
c) performing a consolidation of at least two nodes of each of said at least two similar segmentation paths, based on said predefined criterion, giving rise to at least one consolidated segmentation path.

91. A program storage device readable by machine, tangibly embodying a program of instructions executable by the machine to perform a method of awarding a consumer based on the consumer's activity with regard to a predefined physical site, said activity performed by means of the consumer's mobile device, said method comprising:
a) providing a semantic network having a plurality of segmentation paths, wherein each segmentation path is related to a predefined physical site and includes at least two interconnected nodes, while each node within said at least two interconnected nodes is one of a category, giving rise to a higher-level node, and a sub-category, giving rise to a lower-level node;
b) enabling the consumer to perform an activity with regard to said predefined physical site and said semantic network; and
c) awarding the consumer based on said activity.
